(19) United States
(12) Patent Application Publication
(10) Pub. No.: US 2021/0219110 A1
(43) Pub. Date: Jul. 15, 2021

(54) DEVICE FOR TRANSMITTING AND/OR RECEIVING A MESSAGE IN A COMBINED ASSISTED AND AD-HOC MODE

(71) Applicant: HUAWEI TECHNOLOGIES CO., LTD., SHENZHEN (CN)

(72) Inventors: Apostolos KOUSARIDAS, Munich (DE); Chan ZHOU, Munich (DE)

(21) Appl. No.: 17/144,808

(22) Filed: Jan. 8, 2021

Related U.S. Application Data
(63) Continuation of application No. PCT/EP2019/061184, filed on May 2, 2019.

(30) Foreign Application Priority Data
Jul. 11, 2018 (EP) PCT/EP2018/068798

(51) Int. Cl. H04W 4/40; H04W 76/18

(52) U.S. Cl. CPC H04W 4/40; H04W 84/18; H04W 76/18

(57) ABSTRACT

Example mobile communication methods and devices for transmitting a message over a wireless communication system are described. One example device is configured to select one of an assisted mode, an ad-hoc mode, or a combined assisted and ad-hoc mode, and transmit the message over the selected mode. To support bi-directional transmission, an example device for receiving a message over a wireless communication system is provided, where the device is configured to select one of an assisted mode, an ad-hoc mode, or a combined assisted and ad-hoc mode, and receive the message over the selected mode. An example management device is provided for supporting a device for transmitting or receiving a message over a wireless communication system.

### CROSS-REFERENCE TO RELATED APPLICATIONS

This application is a continuation of International Application No. PCT/EP2019/061184, filed on May 2, 2019, which claims priority to International Patent Application No. PCT/EP2018/068798, filed on Jul. 11, 2018. The disclosures of the aforementioned applications are hereby incorporated by reference in their entireties.

### TECHNICAL FIELD

The present disclosure relates to the field of mobile communication, in particular for vehicle-to-anything (V2X) communication. More specifically, the present disclosure provides a device that can either select an assisted mode, an ad-hoc mode, or a combined assisted and ad-hoc mode to transmit or receive a message, in particular during V2X communication.

### BACKGROUND

With the advent of automated driving functions, especially with the broad availability of vehicles that are capable of supporting higher automation levels, the need for synchronization and coordination among vehicles becomes increasingly necessary. Vehicles communicate directly with each other to extend their perception beyond capabilities and a range offered by their integrated sensors. Cooperative lane change, cooperative collision avoidance, and platooning are typical examples of V2X services, wherein connected automated vehicles participate, and performance requirements of a communication layer are more stringent. For instance, predefined use cases require very reliable communication links, with a very low maximum end-to-end (e2e) latency, and a very high data rate.

Although the desire for high reliability, low latency and high data rate is described herein in view of V2X communications, these requirements are crucial for operation of any mobile communication service. That is, the present disclosure in particular can be applied to any kind of mobile communication service, e.g. 4G or 5G.

To fulfill the mentioned requirements, either a cellular interface (i.e. an interface by which an endpoint device communicates via a radio network infrastructure, also referred to as assisted interface or assisted mode) or a sidelink interface (i.e. an interface by which endpoint devices communicate directly with each other via a radio interface, also referred to as ad-hoc interface or ad-hoc mode) can be used separately, as it is e.g. illustrated in FIG. 21. The exchange of information among vehicles is in many cases localized, while in the context of a same service multiple transmission modes (unicast, broadcast, multicast) are required. Communication systems (e.g. 5G) can support either an assisted (e.g. cellular, or Uu) or an ad-hoc (e.g. sidelink, PC5, or device-to-device (D2D) communication) mode, which have different transmission characteristics and features. For instance, the assisted mode has larger coverage area, while the ad-hoc mode increases a systems capacity through spatial frequency reuse. The spatiotemporal dynamics of communication networks and other parameters (e.g. density of vehicles) affect quality of service (QoS) that a communication interface can provide. In many cases, the achieved QoS of a link between two or more user equipments (UEs) or vehicles (either via the assisted mode or via the ad-hoc mode) may change during the lifetime of a service, e.g. due to radio conditions, or mobility of the vehicle.

For that reason, a dynamic selection of the most suitable communication mode is desired to support a predefined QoS requirement (e.g. regarding delay, throughput, or reliability of a message) of a specific service, in order to utilize the benefits that each communication mode can provide at a specific point of time or location. In the current technology, there is thus a need for communication systems (e.g. 5G systems) that can select and dynamically switch the best communication mode, in order to support a QoS requirement demanded by a service.

In the current technology, 3GPP (The 3^{rd} Generation Partnership Project) has enhanced its architecture to support the features and requirements of V2X services. As mentioned above, there are two modes of operation for V2X communication, namely over the PC5 interface (i.e. the ad-hoc mode) and over the Uu interface (i.e. the assisted mode). The assisted mode is used for transmission and reception of V2X messages via an infrastructure. A UE (user equipment) or vehicle can transmit and receive V2X messages either via Uu unicast downlink or via multimedia broadcast multicast service (MBMS) for multicast or broadcast reception by establishing appropriate (radio and core network) bearers, according to a predefined QoS requirements. The establishment of a Uu link for V2X traffic exchange takes place via radio resource control (RRC) connection establishment messages or via non-access stratum (NAS) messages, in case that a new radio bearer should be established. In both cases the methods and signaling of the current technology focus only on one specific radio interface (i.e. the assisted mode), while there is no consideration of activating, establishing or configuring any sidelink (PC5) link (i.e. the ad-hoc mode).

Support of V2X services via a PC5 interface is provided by V2X sidelink communication, which is a mode of communication in which UEs or vehicles can communicate with each other directly over the PC5 interface (i.e. the ad-hoc mode). Only UEs or vehicles authorized to be used for V2X services can perform V2X sidelink communication. A UE or vehicle supporting V2X sidelink communication can operate in two modes for resource allocation:
Scheduled resource allocation (mode 3): The UE/vehicle needs to be RRC_CONNECTED in order to transmit data. The UE requests transmission resources from an eNodeB (eNB), which schedules dedicated resources for transmission of sidelink control information (SCI) and data.
UE autonomous resource selection (mode 4): The UE/vehicle on its own selects resources from resource pools and performs transport format selection to transmit SCI and data. If a mapping between zones and transmission resource pools is (pre-) configured, the UE/vehicle selects a resource pool based on the zone it is located in. The UE/vehicle performs sensing for (re)selection of sidelink resources. Based on sensing results, the UE/vehicle (re)selects specific sidelink resources and may reserve periodically recurring (i.e. semi-persistent) sidelink resources.

When a UE/vehicle is in RRC_CONNECTED and intends to use the PC5 interface for communication, it sends a sidelink UE information message to the serving cell in order to request assignment of dedicated sidelink resources. In turn, the base station (BS) sends to the UE a RRC connection reconfiguration message (including an SL-V2X-ConfigDedicated information element), to provide to the UE/vehicle with appropriate configuration (e.g. transmit V2X sidelink data based on sensing using one of the resource pools, semi-persistent scheduling (SPS) sidelink transmission, V2X transmission based on sidelink specific buffer status reports (BSR) from the UE/vehicle).

### SUMMARY

As a result, in the current technology there is the drawback that the assisted mode and the ad-hoc mode are configured strictly separately, and that the present network and the control plane signaling does not allow for dynamic selection, dynamic switching or configuration of communication modes in order to maximize communication quality. V2X communication in particular, and to mobile communication in general is subject to this problem of the current technology.

In view of the above-mentioned drawback, the present disclosure aims to improve the conventional communication among UEs or vehicles.

The present disclosure has the object to integrate an assisted mode (e.g. a cellular mode, or Uu) and an ad-hoc mode (e.g. a sidelink communication mode, or PC5) to support dynamic selection and switching of modes as it is desired in the current technology. The selection of the mode (i.e. the communication interface) includes not only the selection of one or the other communication mode (e.g. Uu or PC5), but precisely involves the combination of both communication modes (both modes are used between a source and one or more destination nodes).

That is, an important aspect of the present disclosure is to enable communication systems (e.g. 4G or 5G) to select, combine and dynamically switch a communication mode/interface in order to support a predefined QoS requirement (e.g. delay, data rate, reliability of communication) of a demanding service (e.g. cooperative sensing, platooning, cooperative maneuver, emergency safety messages, periodic awareness messages) and in order to support various types of traffic (unicast, multicast, broadcast). The present disclosure in particular provides a way for a network (e.g. a base station (BS), or core network functions (CN-F)) to decide and provide to a UE/vehicle, together with the initial establishment of a specific service, the communication modes that can be used for a suitable, optimized communication between two or more UEs/vehicles.

Generally, communication modes considered by the present disclosure are: an assisted mode (e.g. cellular, or Uu), an ad-hoc mode (e.g. sidelink, or PC5), a first combined assisted (e.g. cellular, or Uu) and ad-hoc (sidelink, or PC5) mode with packet duplication for link redundancy, and a second combined assisted (e.g. cellular, or Uu) and ad-hoc (sidelink, or PC5) mode with packet splitting for link aggregation. The selected communication modes can e.g. be dynamically switched during the lifetime of a service either by a BS, that is, network-initiated, or by a UE-initiated trigger for the change of communication modes, in particular between two or more UEs/vehicles. The network preferably makes the initial selection and the update by estimating QoS that each communication mode can provide at a specific point of time or location, by e.g. collecting measurements, context information and QoS reporting from UEs/vehicles, BSs and other involved network entities. An appropriate configuration of a routing function of each transmitting or receiving entity can be provided by the network, e.g. using RRC configuration messages during session, connection, or link establishment or update. A user plane routing function (e.g. for data packets duplication, splitting etc.) can be placed at different layers, e.g. an application layer, a service data adaptation protocol (SDAP) layer, a packet data convergence protocol (PDCP) layer, a radio link control (RLC) layer, or a media access control (MAC) layer.

The objective of the present disclosure is achieved by the solution provided in the enclosed independent claims. Advantageous implementations of the present disclosure are further defined in the dependent claims.

A first aspect of the present disclosure provides a device for transmitting a message over a wireless communication system, in particular a UE, wherein the device is configured to select one of an assisted mode, an ad-hoc mode, or a combined assisted and ad-hoc mode; and transmit the message over the selected mode.

Alternatively the first aspect of the present disclosure provides a device for transmitting a message over a wireless communication system, in particular a UE, wherein the device is configured to perform at least one of the following:
determine whether to transmit a message based on an availability indication,
determine whether to establish a communication session or link based on the availability indication;
manage a communication failure based on the availability indication;
safely release or re-configure a communication with one or more devices based on the availability indication;
select one of an assisted mode, an ad-hoc mode, or a combined assisted and ad-hoc mode based on an availability indication and transmit the message over the selected mode;
manage a communication link based on an availability indication.

This is beneficial since it increases flexibility of communication networks and in particular V2X services. Several modes can be selected, wherein in particular the combined assisted and ad-hoc mode allows for increasing reliability, redundancy and data-rate, by combining both the assisted mode and the ad-hoc mode. This also allows for better coordination of available assisted mode and ad-hoc mode resources by utilizing all available communication modes. Further, a desired QoS level can be maintained and guaranteed by adapting (i.e. by dynamically switching) the selected mode.

In an implementation form of the first aspect, the device is further configured to, in the combined assisted and ad-hoc mode, transmit the message over the assisted mode and transmit the message over the ad-hoc mode.

This ensures that reliability of communication is increased since a same message is transmitted via the assisted mode, and is also transmitted via the ad-hoc mode. If the message that is sent by one of the modes is lost, it still arrives at a receiving side as it is also transmitted by the other mode.

In a further implementation form of the first aspect, the device is further configured to, in the combined assisted and ad-hoc mode, transmit a first message over the assisted mode and transmit a second message over the ad-hoc mode, wherein the first and the second message belong to the same service.

This ensures that throughput is increased and redundancy is reduced, since the capabilities of both modes can be combined and a higher data-rate is possible, while less time is required to transmit an overall amount of messages relating to a same service.

In a further implementation form of the first aspect, the device is further configured to provide the availability indication to at least one upper layer.

In a further implementation form of the first aspect, the device is further configured to, in the combined assisted and ad-hoc mode, split the message into a first part and a second part, and transmit the first part over the assisted mode and transmit the second part over the ad-hoc mode.

This ensures that throughput is increased and redundancy is reduced, since the capabilities of both modes can be combined and a higher data-rate is possible, while less time is required to transmit an overall message that is split into several message parts.

In a further implementation form of the first aspect, the device is further configured to select the mode, or estimate the availability indication based on a configuration that defines the mode to be used for the message or at least one of the following selection criteria, or to transmit at least one of the following selection criteria to a management device: QoS-information; a service type parameter; involved mobile devices, in particular vehicles, or information based on other mobile devices; radio information, in particular channel measurement; or location information or path information.

The QoS-information may e.g. include latency, data rate, packet error, rate, bit error rate, etc. The radio information may further include, channel busy ratio (CBR), received power, interference, signal strength. QoS information and radio information can include current or expected values as well as different measurement configurations (e.g., per UE, average, per cell, per resource pool etc.).

This is beneficial, as the device can determine, based on a configuration, which mode to use for a predefined type of service or message. The configuration can e.g. be pre-stored in the device or can be provided to or updated in the device by means of a network side device or management device.

This is further beneficial, since the device can base the selection of a mode on at least one of the above mentioned selection criteria, which ensures that a predefined QoS level can be complied with. It is further beneficial that the selection criteria can not only be obtained by the device for use in the device, but also can be shared with a network, e.g. by providing them to a management device.

In a further implementation form of the first aspect, the at least one selection criterion is pre-stored in the device, or determined by the device, or externally provided to the device.

This ensures that a QoS level can be fulfilled by the device, by pre-storing in, or determining by the device, the selection criteria. It is further beneficial that selection criteria obtained in the network can be provided to the device, since the device can use synergetic effects and does not have to obtain the criteria itself.

In a further implementation form of the first aspect, the device is further configured to receive a mode selection request, and select the mode based on the received mode selection request, or initiatively select the mode.

This ensures that the device can select the mode by receiving a request, e.g. from another UE or from a network side device or management device. This request may include QoS requirements that have to be fulfilled, so that the device can select a mode based on the request, and also based on QoS-requirements, e.g. at least one of the selection criteria. However, since the device can also initiatively select the mode, it does not require an external request for selecting or changing a mode. The device can e.g. continuously monitor QoS-parameters or selection criteria, and base a decision for mode selection exclusively on that monitoring.

In a further implementation form of the first aspect, the QoS-information includes a mapping between a first QoS-parameter and a second QoS-parameter, preferably wherein the first QoS-parameter relates to the assisted mode, and wherein the second QoS-parameter relates to the ad-hoc mode.

This is beneficial, since it allows to compare QoS-parameters, properties and requirements of several communication modes. When selecting a mode to meet an overall QoS-requirement, the device can thus compare QoS properties of the assisted mode, the ad-hoc mode, and the overall requirement, to make a mode selection.

In a further implementation form of the first aspect, the device is further configured to perform the selection operation related to at least one of the following layers: an application layer; a service data adaptation protocol (SDAP) layer; a packet data convergence protocol (PDCP) layer; a radio link control (RLC) layer; a media access control (MAC) layer.

This ensures that the device can be implemented in relation to at least one of the above mentioned communication layers, which simplifies integration of the device into a present communication system.

In a further implementation form of the first aspect, the device is further configured to estimate the availability of the sidelink interface (i.e. the ad-hoc mode) or the cellular interface (i.e. the assisted mode), based on the selection criteria.

In a further implementation form of the first aspect, the device can use the availability indication to decide to transmit a packet or not, or to select interface, or to select radio access technology, for link management or for communication failure management, or to cooperate with other devices e.g., to safely release or re-configure a communication with one or more devices, or to provide the availability or unavailability to other devices.

In a further implementation form of the first aspect, the availability indication can be obtained for at least one of the following configurations or combinations of these configurations:
per communication interface/mode,
per radio access technology,
per type or category of service, since different services may have different QoS requirements,
per carrier,
per resource pool,
per quality of service class,
per type of traffic, for example Unicast, groupcast, broadcast.

In a further implementation form of the first aspect, the device can provide the availability indication to upper layers e.g., application layer, on demand or periodically, or event-driven.

In a further implementation form of the first aspect, in the per communication interface or communication mode configuration, the availability indication is provided for at least one of the following modes: the ad-hoc mode, the assisted mode, or combination of the ad-hoc mode and assisted mode.

A second aspect of the present disclosure provides a method for transmitting a message over a wireless communication system, the method comprising the operations of: selecting one of an assisted mode, an ad-hoc mode, or a combined assisted and ad-hoc mode; and transmitting the message over the selected mode.

Alternatively the second aspect of the present disclosure provides a method for transmitting a message over a wireless communication system, the method comprising the operations of: determining whether to transmit a message based on an availability indication, or selecting one of an assisted mode, an ad-hoc mode, or a combined assisted and ad-hoc mode based on an availability indication and transmit the message over the selected mode; or managing a communication link based on an availability indication.

In an implementation form of the second aspect, the method further includes, in the combined assisted and ad-hoc mode, transmitting the message over the assisted mode and transmitting the message over the ad-hoc mode.

In a further implementation form of the second aspect, the method further includes, in the combined assisted and ad-hoc mode, transmitting a first message over the assisted mode and transmitting a second message over the ad-hoc mode, wherein the first and the second message belong to the same service.

In a further implementation form of the second aspect, the method further includes, in the combined assisted and ad-hoc mode, splitting the message into a first part and a second part, and transmitting the first part over the assisted mode and transmitting the second part over the ad-hoc mode.

In a further implementation form of the second aspect, the method further includes selecting the mode based on a configuration that defines the mode to be used for the message or at least one of the following selection criteria, or transmitting at least one of the following selection criteria to a management device: QoS-information; a service type parameter; involved mobile devices, in particular vehicles, or information based on other mobile devices; radio information, in particular channel measurement; or location information or path information.

The QoS-information may e.g. include latency, data rate, packet error, rate, bit error rate, etc. The radio information may further include, channel busy ratio (CBR), received power, interference, signal strength. QoS information and radio information can include current or expected values as well as different measurement configurations (e.g., per UE, average, per cell, per resource pool etc.).

In a further implementation form of the second aspect, the at least one selection criterion is pre-stored in the device, or determined by the device, or externally provided to the device.

In a further implementation form of the second aspect, the method further includes, receiving a mode selection request, and selecting the mode based on the received mode selection request, or initiatively selecting the mode.

In a further implementation form of the second aspect, the QoS-information includes a mapping between a first QoS-parameter and a second QoS-parameter, preferably wherein the first QoS-parameter relates to the assisted mode, and wherein the second QoS-parameter relates to the ad-hoc mode.

In a further implementation form of the second aspect, the method further includes performing the selection operation related to at least one of the following layers: an application layer; a service data adaptation protocol (SDAP) layer; a packet data convergence protocol (PDCP) layer; a radio link control (RLC) layer; a media access control (MAC) layer.

In a further implementation form of the second aspect, the method is further includes estimating the availability of the sidelink interface (i.e. the ad-hoc mode) or the cellular interface (i.e. the assisted mode), based on the selection criteria.

In a further implementation form of the second aspect, the method can use the availability indication to decide to transmit a packet or not, or to select interface, or to select radio access technology, for link management or for communication failure management, or to cooperate with other devices e.g., to safely release or re-configure a communication with one or more devices, or to provide the availability or unavailability to other devices.

In a further implementation form of the second aspect, the availability indication can be provided for at least one of the following configurations or combinations of these configurations:
per communication interface/mode,
per radio access technology,
per type or category of service, since different services may have different QoS requirements,
per carrier,
per resource pool,
per quality of service class,
per type of traffic, for example Unicast, groupcast, broadcast.

In a further implementation form of the second aspect, the method can provide the availability indication to upper layers e.g., application layer, on demand or periodically, or event-driven.

The second aspect and its implementation forms include the same advantages as the first aspect and its implementation forms.

A third aspect of the present disclosure provides a device for receiving a message over a wireless communication system, in particular a UE, wherein the device is configured to: select one of an assisted mode, an ad-hoc mode, or a combined assisted and ad-hoc mode; and receive the message over the selected mode.

Alternatively the third aspect of the present disclosure provides a device for receiving a message over a wireless communication system, in particular a UE, wherein the device is configured to:
obtain an availability indication;
perform at least one of the following:
determine whether to receive a message based on the availability indication, determine whether to establish a communication session or link based on the availability indication;
manage a communication failure based on the availability indication;
safely release or re-configure a communication with one or more devices based on the availability indication;
select one of an assisted mode, an ad-hoc mode, or a combined assisted and ad-hoc mode; and receive the message over the selected mode;
manage a communication link based on the availability indication.

In an implementation form of the third aspect, the device is further configured to provide the availability indication to at least one upper layer.

In an implementation form of the third aspect, the device is further configured to, in the combined assisted and ad-hoc mode, receive the message over the assisted mode and receive the message over the ad-hoc mode.

In a further implementation form of the third aspect, the device is further configured to, in the combined assisted and ad-hoc mode, receive a first message over the assisted mode and receive a second message over the ad-hoc mode, wherein the first message and the second message belong to the same service.

In a further implementation form of the third aspect, the device is further configured to, in the combined assisted and ad-hoc mode, receive a first part of the message over the assisted mode and receive a second part of the message over the ad-hoc mode, and combine the first part and the second part to obtain the message.

In a further implementation form of the third aspect, the device is further configured to select the mode or estimate the availability indication based on a configuration that defines the mode to be used for the message or at least one of the following selection criteria, or to transmit at least one of the following selection criteria to a management device: QoS-information; a service type parameter; involved mobile devices, in particular vehicles, or information based on other mobile devices; radio information, in particular channel measurement; or location information or path information.

The QoS-information may e.g. include latency, data rate, packet error, rate, bit error rate, etc. The radio information may further include, channel busy ratio (CBR), received power, interference, signal strength. QoS information and radio information can include current or expected values as well as different measurement configurations (e.g., per UE, average, per cell, per resource pool etc.).

In a further implementation form of the third aspect, the at least one selection criterion is pre-stored in the device, or determined by the device, or externally provided to the device.

In a further implementation form of the third aspect, the device is further configured to receive a mode selection request, and select the mode based on the received mode selection request, or initiatively select the mode.

In a further implementation form of the third aspect, the QoS-information includes a mapping between a first QoS-parameter and a second QoS-parameter, preferably wherein the first QoS-parameter relates to the assisted mode, and wherein the second QoS-parameter relates to the ad-hoc mode.

In a further implementation form of the third aspect, the device is further configured to perform the selection operation related to at least one of the following layers: an application layer; a service data adaptation protocol (SDAP) layer; a packet data convergence protocol (PDCP) layer; a radio link control (RLC) layer; a media access control (MAC) layer.

In a further implementation form of the third aspect, the device is further configured to estimate the availability of the sidelink interface (i.e. the ad-hoc mode) or the cellular interface (i.e. the assisted mode), based on the selection criteria.

In a further implementation form of the third aspect, the device can use the availability indication to decide to receive a packet or not, or to select interface, or to select radio access technology, for link management or for communication failure management, or to cooperate with other devices e.g., to safely release or re-configure a communication with one or more devices, or to provide the availability or unavailability to other devices.

In a further implementation form of the third aspect, the availability indication can be provided for at least one of the following configurations or combinations of these configurations:
per communication interface/mode,
per radio access technology,
per type or category of service, since different services may have different QoS requirements,
per carrier,
per quality of service class,
per type of traffic, for example Unicast, groupcast, broadcast.

In a further implementation form of the third aspect, the device can provide the availability indication to upper layers e.g., application layer, on demand or periodically, or event-driven.

In a further implementation form of the third aspect, in the per communication interface or communication mode configuration, the availability indication is provided for at least one of the following modes: the ad-hoc mode, the assisted mode, or combination of the ad-hoc mode and assisted mode.

The third aspect and its implementation forms include the same advantages as the first aspect and its implementation forms, however in view of a receiving side device.

In a further implementation form of the third aspect, the device is further configured to estimate the availability indication based on the at least one selection criteria and the selected configuration.

A fourth aspect of the present disclosure provides a method for receiving a message over a wireless communication system, the method comprising the operations of: selecting one of an assisted mode, an ad-hoc mode, or a combined assisted and ad-hoc mode; and receiving the message over the selected mode.

Alternatively the fourth aspect of the present disclosure provides a method for receiving a message over a wireless communication system, the method comprising the operations of:
obtaining an availability indication
performing at least one of the following:
determining whether to receive a message based on the availability indication, determining whether to establish a communication session or link based on the
availability indication;
managing a communication failure based on the availability indication;
safely releasing or re-configure a communication with one or more devices;
selecting one of an assisted mode, an ad-hoc mode, or a combined assisted and ad-hoc mode; and receive the message over the selected mode; a
managing a communication link based on the availability indication.

In an implementation form of the fourth aspect, the method further includes, in the combined assisted and ad-hoc mode, receiving the message over the assisted mode and receiving the message over the ad-hoc mode.

In a further implementation form of the fourth aspect, the method further includes, in the combined assisted and ad-hoc mode, receiving a first message over the assisted mode and receiving a second message over the ad-hoc mode, wherein the first message and the second message belong to the same service.

In a further implementation form of the fourth aspect, the method further includes, in the combined assisted and ad-hoc mode, receiving a first part of the message over the assisted mode and receiving a second part of the message over the ad-hoc mode, and combining the first part and the second part to obtain the message.

In a further implementation form of the fourth aspect, the method further includes selecting the mode based on a configuration that defines the mode to be used for the message or at least one of the following selection criteria, or transmitting at least one of the following selection criteria to a management device: QoS-information; a service type parameter; involved mobile devices, in particular vehicles, or information based on other mobile devices; radio information, in particular channel measurement; or location information or path information.

The QoS-information may e.g. include latency, data rate, packet error, rate, bit error rate, etc. The radio information may further include, channel busy ratio (CBR), received power, interference, signal strength. QoS information and radio information can include current or expected values as well as different measurement configurations (e.g., per UE, average, per cell, per resource pool etc.).

In a further implementation form of the fourth aspect, the at least one selection criterion is pre-stored in the device, or determined by the device, or externally provided to the device.

In a further implementation form of the fourth aspect, the method further includes receiving a mode selection request, and selecting the mode based on the received mode selection request, or initiatively selecting the mode.

In a further implementation form of the fourth aspect, the QoS-information includes a mapping between a first QoS-parameter and a second QoS-parameter, preferably wherein the first QoS-parameter relates to the assisted mode, and wherein the second QoS-parameter relates to the ad-hoc mode.

In a further implementation form of the fourth aspect, the method further includes performing the selection operation related to at least one of the following layers: an application layer; a service data adaptation protocol (SDAP) layer; a packet data convergence protocol (PDCP) layer; a radio link control (RLC) layer; a media access control (MAC) layer.

In a further implementation form of the fourth aspect, the method is further configured to estimate the availability of the sidelink interface (i.e. the ad-hoc mode) or the cellular interface (i.e. the assisted mode), based on the selection criteria.

In a further implementation form of the fourth aspect, method device can use the availability indication to decide to receive a packet or not, or to select interface, or to select radio access technology, for link management or for communication failure management, or to cooperate with other devices e.g., to safely release or re-configure a communication with one or more devices, or to provide the availability or unavailability to other devices.

In a further implementation form of the fourth aspect, the availability indication can be provided for at least one of the following configurations or combinations of these configurations:
per communication interface/mode,
per radio access technology,
per type or category of service, since different services may have different QoS requirements,
per carrier,
per resource pool,
per quality of service class,
per type of traffic, for example Unicast, groupcast, broadcast.

In a further implementation form of the fourth aspect, the device can provide the availability indication to upper layers e.g., application layer, on demand or periodically, or event-driven.

The fourth aspect and its implementation forms include the same advantages as the third aspect and its implementation forms.

A fifth aspect of the present disclosure provides a management device, in particular a network device, for supporting a device for transmitting or receiving a message over a wireless communication system, wherein the device is configured to: select one of an assisted mode, an ad-hoc mode, or a combined assisted and ad-hoc mode; or select at least one selection criterion; or transmit the selected mode or the selection criterion to the device for transmitting or receiving a message over a wireless communication system.

Alternatively, the fifth aspect provides a management device, in particular a network device, for supporting a device for transmitting or receiving a message over a wireless communication system, wherein the device is configured to: obtain an availability indication; select one of an assisted mode (1701), an ad-hoc mode (1702), or a combined assisted and ad-hoc mode (1703) based on availability indication; or select at least one selection criterion; or transmit the availability indication to the device for transmitting or receiving a message over a wireless communication system or to a base station.

This ensures that the device according to the first or third aspect, or a base station can be supported by the management device, as the selection can already be performed in the management device, and a result can be sent to the device or base station. Since the management has a better overview of a whole communication system, this makes the decision more accurate, since more information can be considered. Also, processing in the device is reduced. Transmitting the selection criterion to the device or base station helps these entities to obtain more selection criteria and make better mode selection by themselves.

In an implementation form of the fifth aspect, the management device is further configured to receive selection criteria, in particular from a device for transmitting or receiving a message over a wireless communication system.

This ensures that selection criteria can be shared throughout a communication network, and that overall QoS, and overall mode selection in the communication network can be improved.

In a further implementation form of the fifth aspect, the management device is further configured to generate a mapping between a first QoS-parameter and a second QoS-parameter, preferably wherein the first QoS-parameter relates to the assisted mode or wherein the second QoS-parameter relates to the ad-hoc mode.

This ensures that mappings regarding QoS parameters can be shared throughout a communication network, and that overall QoS, and overall mode selection in the communication network can be improved.

In a further implementation form of the fifth aspect, the management device is further configured to transmit the selected mode/and or the at least one criterion to another base station or to more than one base station.

This ensures that a base station can be supported by the management device, as the selection can already be performed in the management device, and a result can be sent to the base station. Since the management device has a better overview of a whole communication system, this makes the decision more accurate, since more information can be considered. Also, processing in the base station is reduced.

A sixth aspect of the present disclosure provides a method for operating a management device, in particular a network device, for supporting a device for transmitting or receiving a message over a wireless communication system, the method (2000) comprising the operations of: selecting one of an assisted mode, an ad-hoc mode, or a combined assisted and ad-hoc mode; or selecting at least one selection criterion; or transmitting the selected mode or the selection criterion to the device for transmitting or receiving a message over a wireless communication system; or transmit the availability indication to the device for transmitting or receiving a message over a wireless communication system or to a base station.

A sixth aspect of the present disclosure provides a method for operating a management device, in particular a network device, for supporting a device for transmitting or receiving a message over a wireless communication system, the, the method comprising the operations of: obtaining an availability indication; selecting one of an assisted mode, an ad-hoc mode, or a combined assisted and ad-hoc mode based on the availability indication; selecting at least one selection criterion; or transmitting the selected mode, the selection criterion, or the availability indication to the device for transmitting or receiving a message over a wireless communication system.

In an implementation form of the sixth aspect, the method further includes receiving selection criteria, in particular from a device for transmitting or receiving a message over a wireless communication system.

In a further implementation form of the sixth aspect, the method further includes generating a mapping between a first QoS-parameter and a second QoS-parameter, preferably wherein the first QoS-parameter relates to the assisted mode or wherein the second QoS-parameter relates to the ad-hoc mode.

In a further implementation form of the sixth aspect, the method further includes transmitting the selected mode/and or the at least one criterion to another base station or to more than one base station.

The sixth aspect and its implementation forms include the same advantages as the fifth aspect and its implementation forms.

It has to be noted that all devices, elements, units and means described in the present application could be implemented in the software or hardware elements or any kind of combination thereof. All operations which are performed by the various entities described in the present application as well as the functionalities described to be performed by the various entities are intended to mean that the respective entity is adapted to or configured to perform the respective operations and functionalities. Even if, in the following description of specific embodiments, a specific functionality or operation to be performed by external entities is not reflected in the description of a specific detailed element of that entity which performs that specific operation or functionality, it should be clear for a skilled person that these methods and functionalities can be implemented in respective software or hardware elements, or any kind of combination thereof.

### BRIEF DESCRIPTION OF DRAWINGS

The above-described aspects and implementation forms of the present disclosure will be explained in the following description of specific embodiments in relation to the enclosed drawings, in which

FIG. 1 shows a schematic view of a device according to an embodiment of the present disclosure.

FIGS. 2A-2C_shows a schematic view of a device according to an embodiment of the present disclosure in more detail.

FIGS. 3A-3B shows a schematic view of an operating scenario of the device.

FIG. 4 shows another schematic view of an operating scenario of the device.

FIG. 5 shows a schematic view of a method for mode selection.

FIG. 6 shows a schematic view of corresponding QoS mappings.

FIG. 7 shows a schematic view of an operating principle of a device according to the present disclosure.

FIG. 8 shows a schematic view of an operating principle of a device according to the present disclosure.

FIG. 9 shows a schematic view of an operating principle of a device according to the present disclosure.

FIG. 10 shows a schematic view of an operating principle of a device according to the present disclosure.

FIG. 11 shows a schematic view of an operating principle of a device according to the present disclosure.

FIG. 12 shows a schematic view of layer integration.

FIG. 13 shows a schematic view of an interface between layers.

FIG. 14 shows a schematic view of interaction between assisted mode and ad-hoc mode layers.

FIG. 15 shows a schematic view of a device according to an embodiment of the present disclosure.

FIGS. 16A-16C shows a schematic view of a device according to an embodiment of the present disclosure in more detail.

FIG. 17 shows a schematic view of a management device according to an embodiment of the present disclosure.

FIG. 18 shows a schematic view of a method according to an embodiment of the present disclosure.

FIG. 19 shows a schematic view of a method according to an embodiment of the present disclosure.

FIG. 20 shows a schematic view of a method according to an embodiment of the present disclosure.

FIG. 21 shows a schematic view of a communication system according to the current technology.

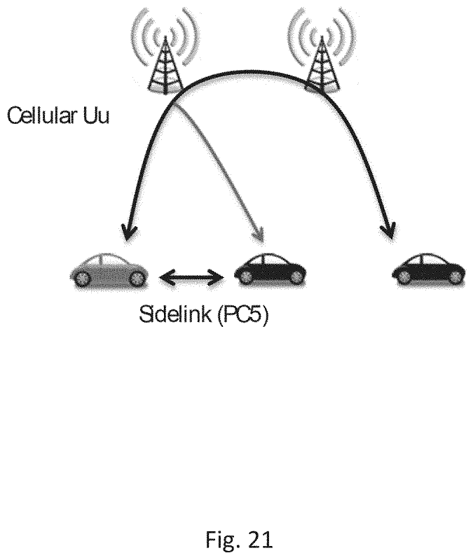

### DETAILED DESCRIPTION OF EMBODIMENTS

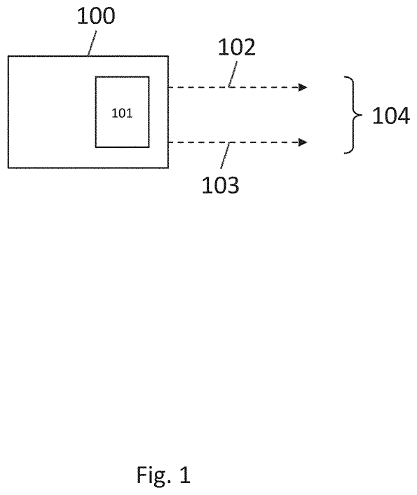

FIG. 1 shows, a device 100 for transmitting a message (e.g. user plane data packet) 101 over a wireless communication system. The device 100 can in particular be a UE, e.g. for use in a vehicle, or a vehicle. To transmit the message 101, the device 100 is configured to select one of an assisted mode 102, an ad-hoc mode 103, or a combined assisted and ad-hoc mode 104. The selection can also comprise specification of one or more resources related to the selected mode, e.g. a predefined resource block used for the assisted mode. After the selection is performed, the message 101 is transmitted over the selected mode. The selection can e.g. be an initial selection, that is, the mode is selected for the first time, e.g. at startup. The selection can also include changing a presently used mode to a newly selected mode.

In other words, the device 100 enables initial selection of a communication mode (which can include session/connection establishment) for a service, in particular a V2X service. The mode can be the assisted mode (e.g. cellular, or Uu), the ad-hoc mode (e.g. sidelink, or PC5), or the combined assisted and ad-hoc mode (e.g. cellular, or Uu, and sidelink, or PC5). Further, the device 100 allows for dynamic switching of the communication mode, during the lifetime of the service. That is, during operation the mode can be newly selected, e.g. network-initiated, that is based on a request that is received from a network side device (e.g. a management device), but also UE-initiated, that is based on a determination of the device 100 itself.

Moreover, the device 100 obtains the availability indication of assisted mode (e.g. cellular, or Uu), or the ad-hoc mode (e.g. sidelink, or PC5), or the combined assisted and ad-hoc mode (e.g. cellular, or Uu, and sidelink, or PC5).

The availability indication can be used by device 100 to determine whether to transmit a message; or to select one of an assisted mode, an ad-hoc mode, or a combined assisted and ad-hoc mode and transmit the message over the selected mode; or to manage a communication link.

Moreover, the device 100 can use the availability indication to determine whether to establish a communication session or link; or to manage a communication failure; or to safely release a communication and/or application service; or to re-configure a communication with one or more devices. For instance, a UE can switch to another communication mode, based on the availability indication in order to assure the service continuity e.g., of a V2X service.

The device 100 can obtain the availability indication by determining it, for instance by generating, or calculating, or estimating the availability indication based on any selection criteria.

Alternatively the availability information may be obtained by the device 100 by receiving it from another device 100 or another device 1500, or a management device 1700.

For instance, the availability indication of the ad-hoc mode (e.g. sidelink, or PC5) can be obtained using e.g., the Channel Busy Ratio (CBR) of a sidelink resource pool that device 100 measures or the QoS of a sidelink resource pool that device 100 measures. In another example, the availability indication of the assisted mode (e.g. cellular, or Uu) can be obtained using e.g., the cell selection criterion S that device 100 measures or the cell load.

To obtain the availability indication based on the selection criteria by the device 100, the at least one selection criterion can be pre-stored in the device 100, or determined by the device 100, or externally provided to the device 100.

The device 100, can transmit the availability indication to a management device; to another device; to a network entity (e.g., Base Station); or to an application function that is inside or outside a network operator.

The availability indication can be obtained by the device 100 for at least one of the following configurations or combinations of these configurations:
per communication interface/mode (cellular, sidelink),
per radio access technology (e.g., 5G, 4G, IEEE 802.11p),
per type or category of service (e.g., safety, platooning, sensor sharing, convenience, automated driving etc.), since different services may have different QoS requirements,
per carrier,
per resource pool,
per quality of service class or category
per type of traffic, for example Unicast, groupcast, broadcast.

In order to obtain the availability indication for any of the above configurations, device 100 can use selection criteria that is available at the UE or provided by neighboring UEs or network devices. For instance, to obtain the availability indication per type of service and also per communication interface/mode then the device 100 uses radio measurements for the different communication interfaces (e.g., PC5, Uu) and monitored QoS information for the different types of services (e.g., safety, advanced, platooning etc.).

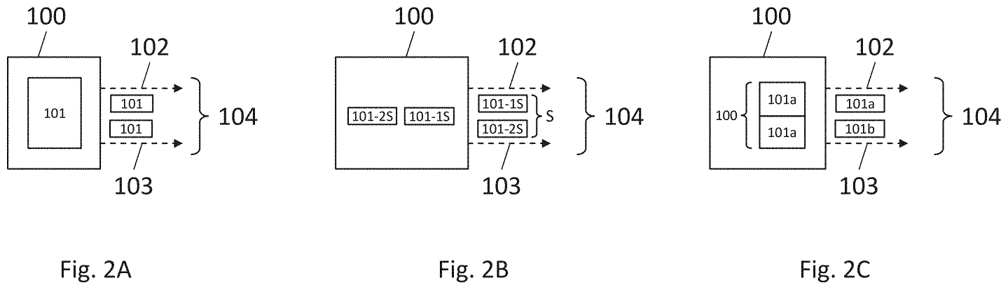

FIGS. 2A, 2B and 2C shows a device 100 according to an embodiment of the present disclosure in more detail. The device 100 of FIGS. 2A-2C includes all features and functionality of the device 100 of FIG. 1. To this end, identical features are labelled with identical reference signs. All features that are going to be described in view of FIG. 2 are optional features of the device 100.

As it is shown in FIG. 2A, the device 100 can be further configured to, in the combined assisted and ad-hoc mode 104, transmit the message 101 over the assisted mode 102 and transmit the message 101 over the ad-hoc mode 103. In other words, the device 100 can use both the assisted mode 102 and the ad-hoc mode 103 for increasing redundancy of a link. The device can be configured to duplicate the message 101 and send the message 101 over the assisted mode 102, and send the duplicate of the massage over the ad-hoc mode 103.

Increasing redundancy of the link helps e.g. to increase reliability of communication. In this case, each data packet (e.g. each message) of a service or data flow (e.g. a V2X service) between two or more UEs or vehicles is transmitted in both the assisted mode and the ad-hoc mode (duplication).

As it is shown in FIG. 2B, the device 100 can further be configured to, in the combined assisted and ad-hoc mode 104, transmit a first message 101-1S over the assisted mode 102 and transmit a second message 101-2S over the ad-hoc mode 103.

In other words, the device 100 can use both the assisted mode 102 and the ad-hoc mode 103 for link aggregation. That is, by splitting a stream of messages, a first message 101-1S is sent over one mode, and a second message 101-2S is sent over the other mode (preferably simultaneously), thereby increasing throughput of messages and decreasing latency of messages.

Link aggregation (which can also be called dual connectivity model) helps e.g. to increase throughput and reduce latency: In this case, different data packets/messages of a service or flow (e.g. a V2X service) between two or more UEs or vehicles are transmitted at both interfaces (split). The exact configuration of the splitting between the one mode and the other mode (e.g. percentage or number of data packets/messages that should be transmitted via the one or the other mode) can be decided either by the device 100 (being e.g. a UE) or received by the device 100 from a network side device (e.g. a management device).

More specifically, the first message 101-1S and the second message 101-2S can belong to a same service S, e.g. a same V2X service.

As it is shown in FIG. 2C, the device 100 can further be configured to, in the combined assisted and ad-hoc mode 104, split the message 101 into a first part 101a and a second part 101b, and transmit the first part 101a over the assisted mode 102 and transmit the second part 101b over the ad-hoc mode 103.

In other words, the device 100 can use both the assisted mode 102 and the ad-hoc mode 103 for link aggregation. That is, by splitting a message, a first part 101a is sent over one mode, and a second part 101b is sent over the other mode (preferably simultaneously), thereby increasing throughput of messages and decreasing latency of messages.

In this example, link aggregation helps e.g. to increase throughput and reduce latency. Different parts of data packets or of messages of a service or flow (e.g. a V2X service) between two or more UEs or vehicles are transmitted at both interfaces (split).

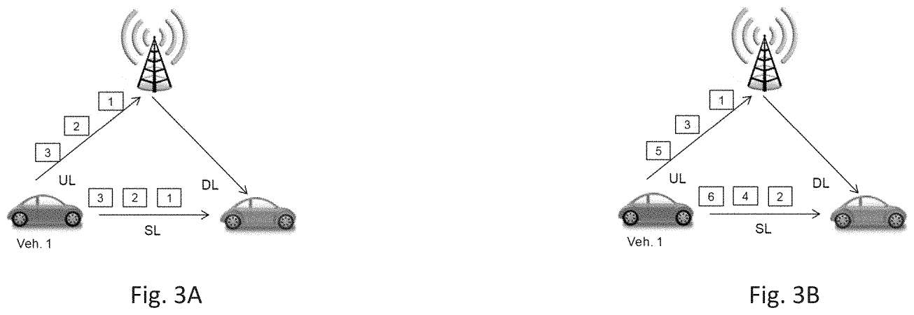

FIG. 3A and FIG. 3B shows two views of multi-path communication, where both modes are used for the communication between two or more vehicles. FIG. 3A relates to the description and illustration of FIG. 2A, while FIG. 3B relates to the illustration and description of FIG. 2B and FIG. 2C. That is, FIG. 3B shows link aggregation in a more abstract manner and does not differentiate between whether a stream of messages is split, and whether each message is split.

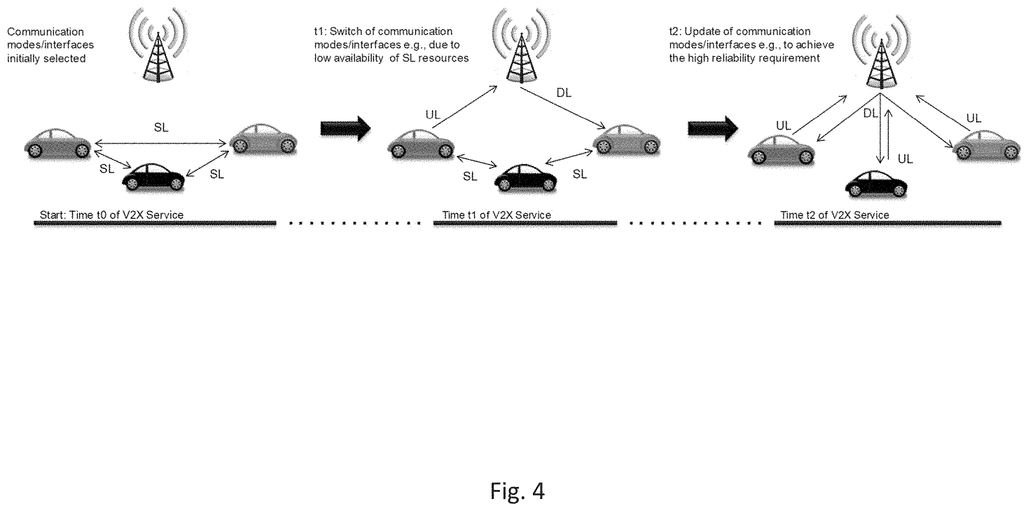

As it is now going to be described in view of FIG. 4, dynamic switching of a communication mode that has been selected between two or more UEs or vehicles in the context of a same service, is used to maintain and guarantee a desired QoS during lifetime of a specific service. FIG. 4 illustrates an example for dynamic switching of a communication mode for a V2X service. The dynamic switching can be network-initiated or UE-initiated. In the context of a same service, a group of involved UEs or vehicles may use different combinations of communication modes according to their QoS requirements and the current network and road conditions.

The decision for dynamic selection or switching of an appropriate communication mode can be taken at a BS, e.g. via RRC messages or any other core network entity (e.g. an access and mobility function (AMF), or a session management function (SMF) in 5G communication networks, or V2X Control Function). This can also be done by a cloud server or a mobile edge computing (MEC) server, taking into account the QoS requirements of a V2X service and current network conditions (e.g. network load) and radio information of each communication interface of corresponding cells or neighboring cells.

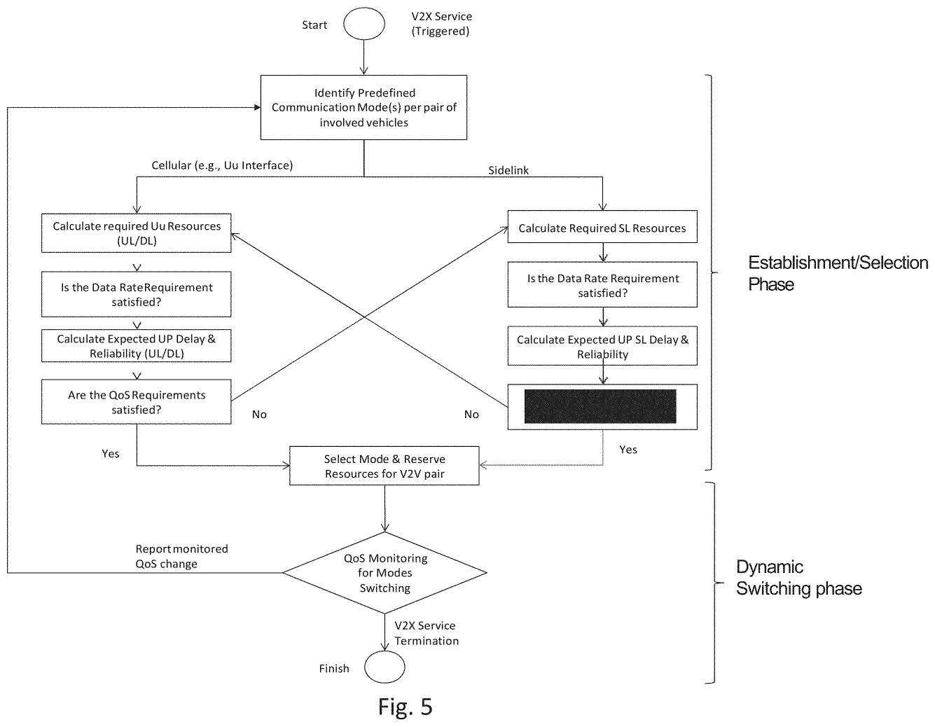

FIG. 5 shows an example of a scheme that can be used for selection or switching of a suitable communication mode.

In order to select a suitable communication mode, the device 100 can also be configured to select the mode based on a configuration that defines the mode to be used for the message 101. That is, depending on a message type, a mode can be selected by the device 100. The configuration thereby can be pre-stored in the device 100, or determined by the device 100, or externally provided to the device 100.

In order to select a suitable communication mode, the device 100 can also be configured to select the mode based on at least one of the following selection criteria: QoS-information; a service type parameter (i.e. a parameter that defines a mode required by a service); involved mobile devices, in particular vehicles, and/or information based on other mobile devices or vehicles; radio information, in particular channel measurement; or location information and/or path information.

The device 100 can also be configured to transmit at least one of the above selection criteria to a management device. Therefore, the respective selection criteria is obtained by the device 100 before. In the management device, the selection criteria can be used for mode selection coordination and to improve overall QoS of a communication system managed by the management device.

To make a decision based on the selection criteria, by the device 100, the at least one selection criterion can be pre-stored in the device 100, or determined by the device 100, or externally provided to the device 100.

The device 100 can also be configured to receive a mode selection request, and select the mode based on the received mode selection request, or initiatively select the mode.

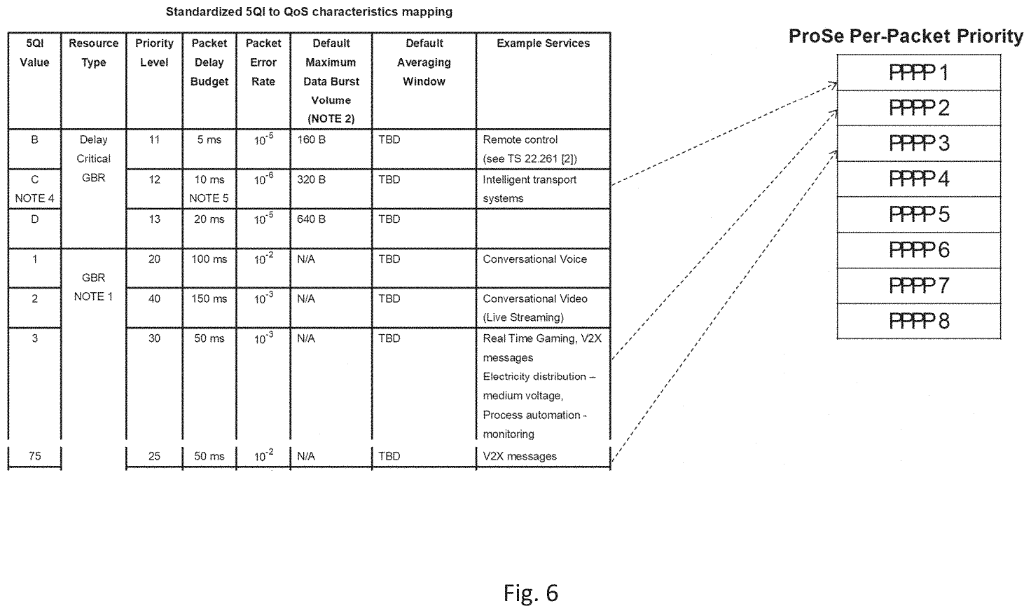

The QoS-information, upon which the mode selection can be based, can include a mapping between a first QoS-parameter and a second QoS-parameter, preferably wherein the first QoS-parameter relates to the assisted mode 102, and wherein the second QoS-parameter and/or relates to the ad-hoc mode 103. The mapping can either be pre-stored or generated in the device, or the mapping can be provided from the network. This mapping concept is going to be described in view of FIG. 6 below in more detail.

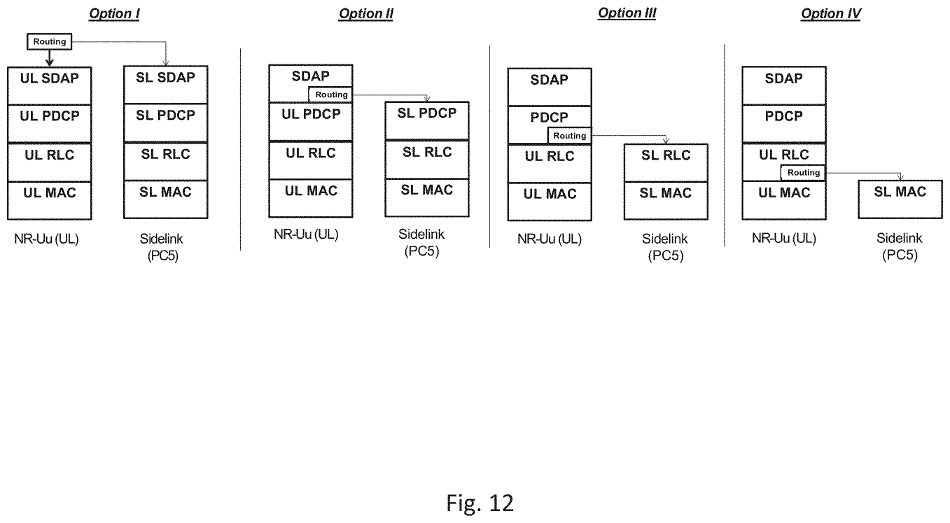

The device 100 can also be configured to perform the selection operation related to at least one of the following layers: an application layer; a service data adaptation protocol (SDAP) layer; a packet data convergence protocol (PDCP) layer; a radio link control (RLC) layer; or a media access control (MAC) layer. In particular, a configuration (such as one of the configurations above) that is received from another device, in particular a network device, can be dependent on a specific layer. Preferably, if the selection operation is performed (e.g. the routing) at the application layer, the device 100 can comprise an interface to forward the selected mode or a configuration from the network layer to the application layer. This concept is going to be described in view of FIG. 12 to FIG. 14 below in more detail.

In view of FIG. 6, the concept of the mapping between the first QoS-parameter and the second QoS-parameter is now going to be described in more detail. As already indicated, different communication modes may have different QoS schemes and mechanisms. An integration of the assisted mode and the ad-hoc mode may require an integration of QoS schemes. For instance, in 5G communication systems, for V2X communication via the cellular Uu interface the NG-RAN and 5GC ensure QoS by mapping packets to appropriate QoS flows and dedicated radio bearers (DRBs). DRBs are selected based on 5QIs (i.e. service requirements), as e.g. described in 3GPP15-23501, and a 2-step mapping of IP-flows to QoS flows (NAS) and from QoS flows to DRBs (access stratum) is used. On the other hand, for V2X communication via sidelink PC5, sidelink quality information is provided via the ProSe per-packet priority (PPPP) and ProSe per-packet reliability (PPPR). PPPP and PPPR are selected by an application layer. The packet delay budget (PDB) of a protocol data unit can be determined from the PPPP. an existing logical channel prioritization based on PPPP is used for V2X sidelink communication.

In the case that the communication modes may have different QoS schemes, a mapping of rules between the cellular (Uu) QoS information and the sidelink (PC5) QoS information is applied. For instance, an example of mapping between 5QIs and PPPP is presented in FIG. 6. These mapping rules can be either pre-defined/pre-specified in the device or provided by the network (distributed on site). In the case that they are predefined they can be stored at the UE/vehicle side or at a V2X application server. Alternatively, they can be retrieved from the network (e.g. PCF, SMF of 5G networks) with a service request or during the initial attachment.

Alternatively, the same QoS information or schemes could be used by both communication modes. For instance the 5QIs and/or radio bearers used for cellular (Uu) interfaces could be also used by the sidelink interface.

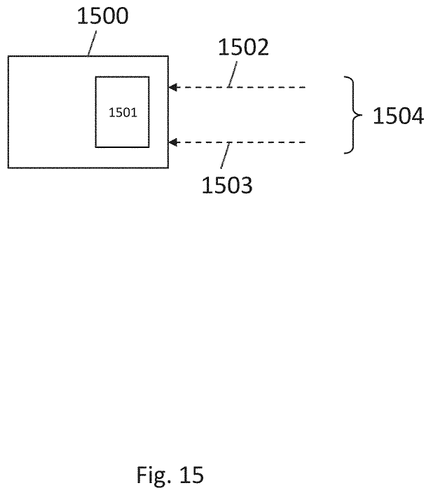

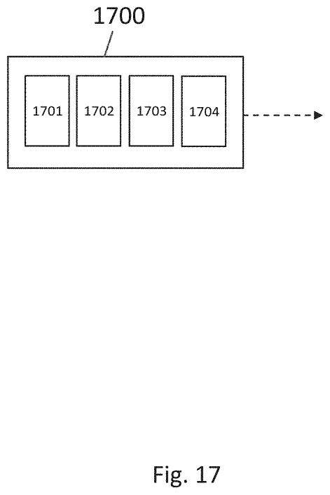

The disclosure in view of FIG. 6 applies to the device 100 of FIG. 1 above, as well as to the device 1500 of FIG. 15 and the device 1700 of FIG. 17 below.

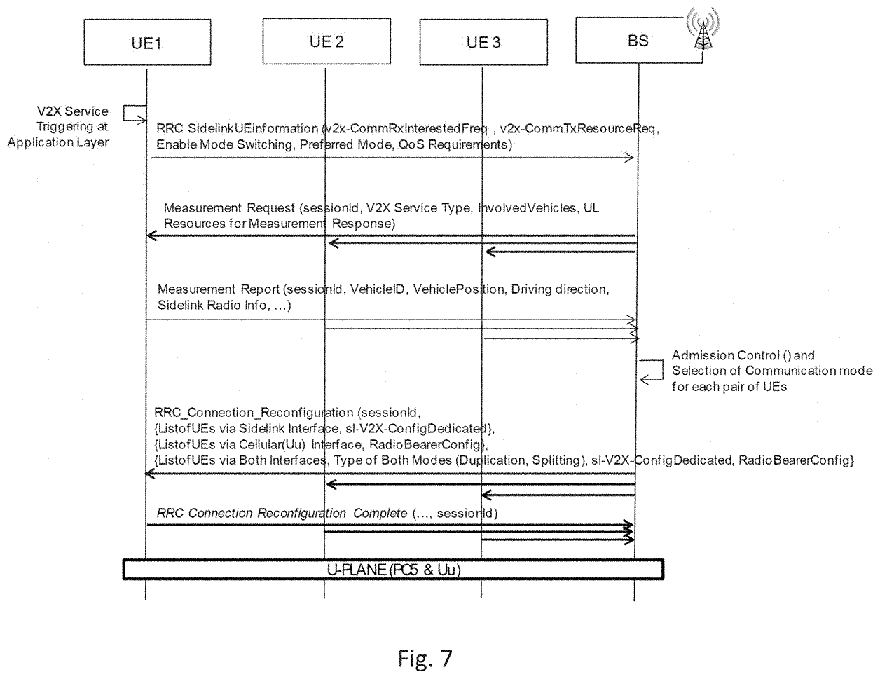

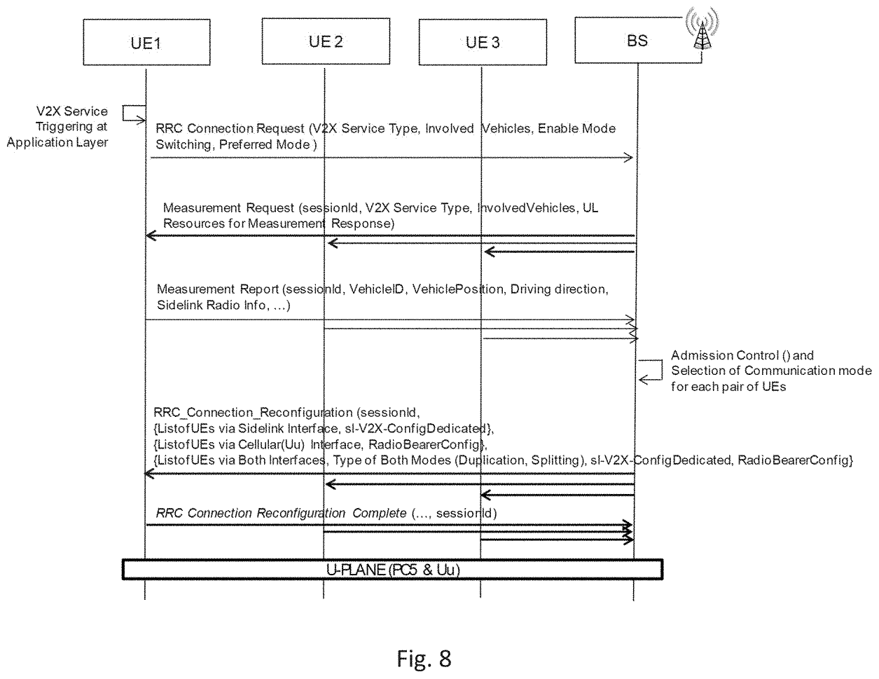

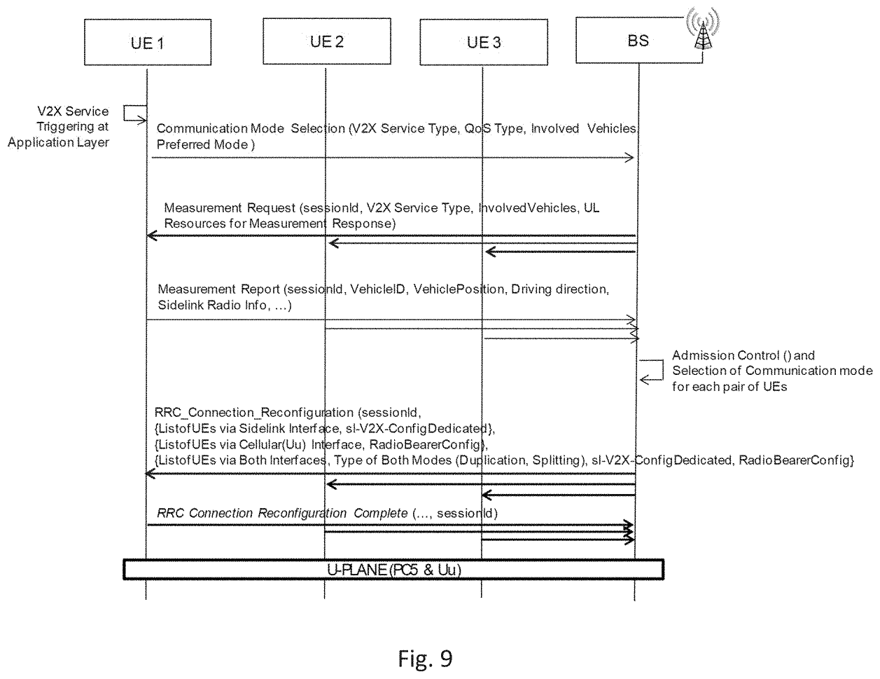

In view of FIG. 7, FIG. 8 and FIG. 9, the selection of a communication mode is now going to be described in detail. A UE, vehicle or application server requests establishment of a connection or the addition of new communication link to support an initiated V2X service. As mentioned above, sidelink (PC5) and cellular (Uu) links use different signaling for the establishment of one or the other communication mode. The present disclosure allows to enable the selection of a most appropriate communication mode by a device, in particular by using and/or extending the initial request that may come from a UE, vehicle or application server. This request may also include information about the requested QoS for the specific service, the preferred mode, or the involved UEs or vehicles.

For instance, when a request for establishing a communication link is sent by a UE or vehicle, then there are three example options that can be considered:

Option I: RRC sidelink UE information is used or extended to enable the selection of the most suitable communication mode for an initiating vehicle or other involved vehicles (cf. FIG. 7).

Option II: RRC and/or NAS messages for DRB/service establishment are used or extended to enable the selection of the most suitable communication mode for an initiating vehicle and/or other involved vehicles (cf. FIG. 8).

Option III: A new RRC or NAS message is introduced that allows the selection of the most suitable communication mode for an initiating vehicle or other involved vehicles. In this case, by default, the capability of communication mode selection is enabled (cf. FIG. 9).

A BS can also request radio (e.g. sidelink radio measurement) and application layer information (e.g. trajectory, direction, location) from the initiating or other involved vehicles, for example by the measurement request message in FIG. 7, 8 or 9. A measurement report is provided by the corresponding UEs or vehicles. Network related information can also be requested by neighboring BSs (and other related network entities). All this information helps the BS to calculate e.g. coverage levels, current or expected QoS that can be supported by any available individual communication interface (cellular, sidelink) or a combination of communication interfaces (both cellular and sidelink).

The communication modes that are selected for each UE or vehicle, or for each pair of UE or vehicle is indicated, for instance via an RRC connection reconfiguration message and application information for the mode selection. The communication modes that could be used between two or more UEs or vehicles include: cellular interface (Uu); sidelink interface (PC5); both interfaces (cellular and sidelink), wherein both interfaces allow for a link redundancy type of communication (packet duplication), or a link aggregation type of communication (packets splitting).

After reception of the decided configuration by the network, the UEs or vehicles undertake to apply the configuration of the communication links and inform the network for the completion of the configuration.

At this point, it should be noted that the decision for the selection of the most suitable communication mode could be also taken by any other core network (CN) entity (e.g. AMF, SMF in 5G communication systems, V2X control function), an MEC, or application function or a server located in the network of a mobile operator or outside. In this case the required context information (e.g. in network or application layer) is forwarded to the corresponding entity mentioned above and the selected configuration is provided to the involved UEs or vehicles. Alternatively, the decision can be taken by each UE/vehicle, based on collected data or proposals by the network.

The disclosure in view of FIGS. 7 to 9 applies to the device 100 of FIG. 1 above, as well as to the device 1500 of FIG. 15 and the device 1700 of FIG. 17 below.

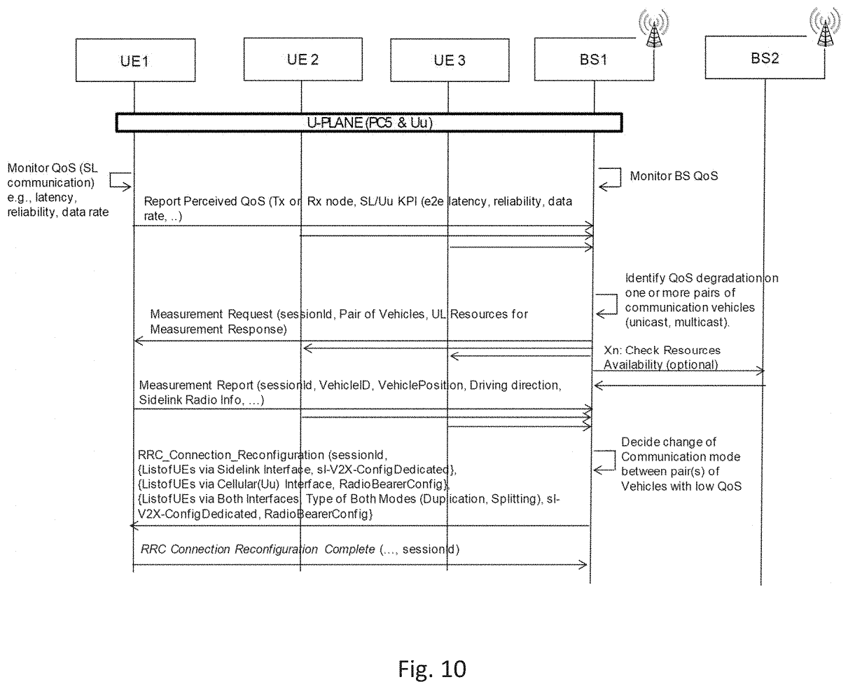

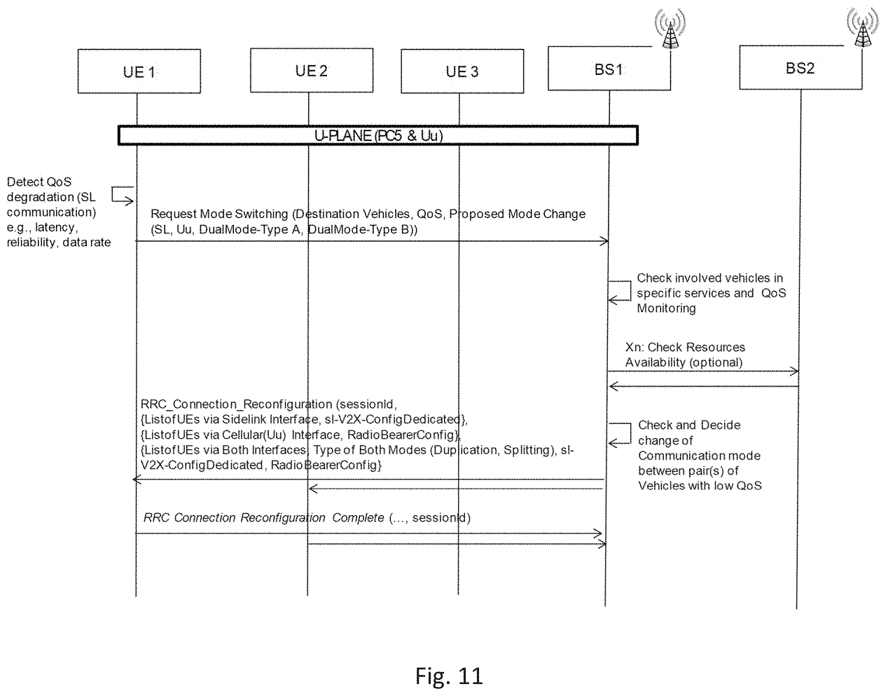

In view of FIG. 10 and FIG. 11, the dynamic switching of communication modes is now going to be described in detail.

Spatiotemporal dynamics of communication networks and other parameters (e.g. vehicle density, or vehicle mobility) affect QoS that a communication mode can provide. In some cases, the achieved QoS of a link between two or more UEs or vehicles (either via the cellular (Uu) interface or via the sidelink (PC5) interface) may change during the lifetime of a service e.g., due to radio conditions, vehicle mobility etc. In this case the dynamic switching to a more suitable communication mode or a combination of both modes can be used to support the QoS requirements (e.g. delay, throughput, reliability) of a specific service and hence utilize the benefits that each communication mode can provide at a specific point of time or location. The dynamic switching could be initiated either by the network or by a UE or vehicle.

In the case of a network-initiated dynamic switching, e.g. a BS (or any network device) identifies QoS degradation of one or more pairs of communicating UEs or vehicles (for unicast or multicast communications), based on information collected by UEs, vehicles, the BSs and other involved entities (cf. FIG. 10). The UEs or vehicles can report the monitored and perceived QoS (e.g. latency, reliability, data rate of the sidelink interface) for an established data link with other vehicles (on a reception and/or transmission side). The QoS reporting can be either periodic or event-triggered, e.g. when one or more key performance indicators (KPIs) (e.g. latency) cannot be supported by the used communication mode. The BS, based on the detected QoS degradation, may ask for measurements from vehicles, or resource availability information from other nodes (e.g. neighboring BS), to decide on communication mode switching. The type of QoS degradation will help the functionality located at the BS to decide on the type of a required change. For instance, if low reliability has been monitored for a specific link between two UEs or vehicles then the BS may decide to enable both interfaces (cellular and sidelink) for the specific pair of UEs or vehicles, where link redundancy type of communication is used (packet duplication). The updated communication modes are provided via RRC connection reconfiguration messages, as happens with the initial selection.

Alternatively, AMF or any other CN Function could be used to make the QoS monitoring and the decision for the dynamic switching of communication modes.

In a second option of dynamic switching (cf. FIG. 11), the vehicle/UE, according to the detected degradation of one or more QoS parameters (e.g. latency, packet loss), triggers the mode switching and sends a proposal to the BS about the preferred communication mode (e.g. change from sidelink to cellular, change from sidelink to both modes (mode type: duplication, enabling links redundancy)).

The BS checks the proposed change, collects QoS information, measurements and context information from other involved UEs or vehicles and involved network nodes (e.g. BSs, or local breakouts). Based on collected information the BS decides the change of communication modes between pair(s) of vehicles with low QoS and notifies the involved vehicles for the updated configuration via RRC connection reconfiguration messages. Even in the case of vehicle-based dynamic switching, the AMF or any other CN Function can be used to collect the various measurement and monitoring reports and decide for the dynamic switching of communication modes/interfaces.

The disclosure in view of FIGS. 10 and 11 applies to the device 100 of FIG. 1 above, as well as to the device 1500 of FIG. 15 and the device 1700 of FIG. 17 below.

In view of FIGS. 12, 13 and 14, different levels of user and data plane integration are now going to be described in detail. In case that both modes (cellular, sidelink) are used for a specific service either for link redundancy (duplication), or link aggregation (splitting), then different levels of integration can be used for a user or data plane. This integration involves routing functions at transmitter side (for packet duplication, or packets splitting) and collection or aggregation functions at receiver side (for packet filtering, merging, etc.). FIG. 12 shows four alternatives for uplink (UL, relating to the cellular mode) and sidelink (SL) integration (from the UE transmitter side/vehicle):

Option I: application layer integration. Option II: integration at the SDAP layer. Option III: integration at the PDCP layer. Option IV: integration at the RLC layer.

In option I of FIG. 12, the application layer undertakes to provide the routing to an appropriate interface (cellular, sidelink) and any duplication or split function (when both modes are used). In this option I, there is the need for an interface/API (Application Programming Interface) between the application layer and the communication layer to provide to the application layer (i.e. routing function) with the configuration that has been decided and provided by the network. The configuration provided from the communication layer to the application includes: Information about initial selection of communication modes (Uu, PC5, Both) and involved vehicles for each mode; and, in case that both communication modes are selected for a pair or group of UEs/vehicles then it is indicated whether packet splitting (i.e. links aggregation) or packet duplication (i.e. link redundancy) should be used; or notification for dynamic mode switching, during V2X service operation. On the other hand the application layer can use this interface to inform the network for successful execution of a configuration, to reject or negotiate with the network for specific configuration (or a selected mode). Both transmitting and receiving nodes should also be aware of any decision from the network. This means that the network provides to the transmitting and receiving nodes that participate to a specific service, the decided configuration (communication modes selected).

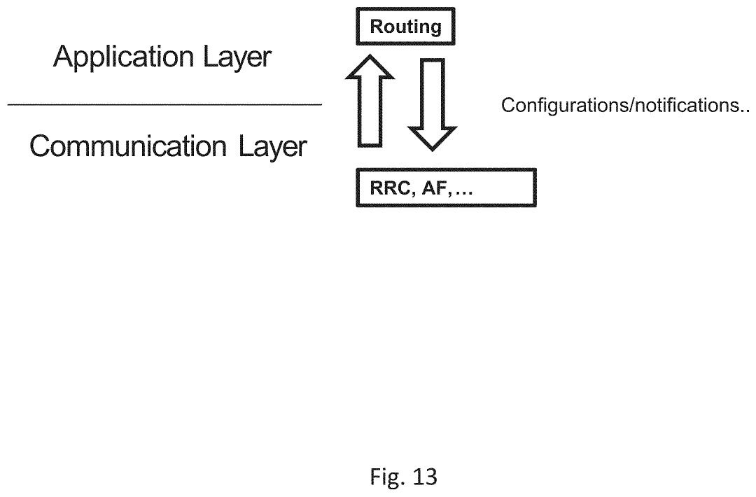

FIG. 13 visualizes this interface/API between the application layer and the communication layer. This interface/API could be implemented between the in-vehicle communication layer and the in-vehicle application layer. In this case e.g., the RRC commands sent by the network for any communication mode selection or switching is forwarded to the application layer. Alternatively this interface/API could be implemented between the in-vehicle application layer and an Application Function (AF) located at the communication network (e.g. V2X application server).

The device, 100 can also transmit the availability indication of assisted mode (e.g. cellular, or Uu), the ad-hoc mode (e.g. sidelink, or PC5), or the combined assisted and ad-hoc mode (e.g. cellular, or Uu, and sidelink, or PC5) to upper layers. If the device is at the communication layer, then the upper layer is the application layer or an intermediate layer between the application and the communication layer. Hence, the application layer can use the availability indication for any application layer purpose. For instance, to determine whether to transmit a message; or to select one of an assisted mode, an ad-hoc mode, or a combined assisted and ad-hoc mode and transmit the message over the selected mode; or to establish a service or request a communication session with one or more devices. Moreover, the device, 100 can transmit the availability indication to an application entity (e.g., an application of a UE, an application server, an application function etc.) on demand, or periodically, or triggered by an event.

In option II of FIG. 12, the routing functionality for user plane data traffic (packets routing to appropriate interface (cellular, sidelink), packet duplication (at transmitter side), split, merge (at receiver side), etc. . . . ) is placed at the SDAP entity. Currently SDAP maps UL QoS flows to DRBs. In this option II, there is the need to extend the RRC signaling sent from the BS to the UEs/vehicles for the configuration of the SDAP and the rules that SDAP has in order to enable the mapping of QoS flows also to the sidelink interface based on the commands received by the BS the SDAP can map a QoS flow: a) to a single mode (Uu or PC5), b) to both modes, by enabling packets splitting (i.e. link aggregation), c) to both modes, by enabling packets duplication (i.e. link redundancy). For different destination vehicles (even in the context of the same service) the source vehicle can use different communication modes. The SDAP is notified by the BS when there is the need to update any rule, which leads to dynamic switching of a communication mode used for a specific destination or a group of vehicles.

In option III of FIG. 12, the routing functionality for user plane data traffic (packet routing to appropriate interface (cellular, sidelink), packet duplication (at transmitter side), split, merge (at receiver side) etc. . . . ) is placed at the PDCP entity. Signaling from the BS described in option II can be used to describe the required configuration of the routing functionality for a specific V2X service.

In option IV of FIG. 12, the routing functionality for user plane data traffic (packet routing to appropriate interface (cellular, sidelink), packets duplication (at transmitter side), split, merge (at receiver side) etc. . . . ) is placed at the RLC entity. Joint scheduling for UL and SL interfaces can also be considered to further optimize the integration.

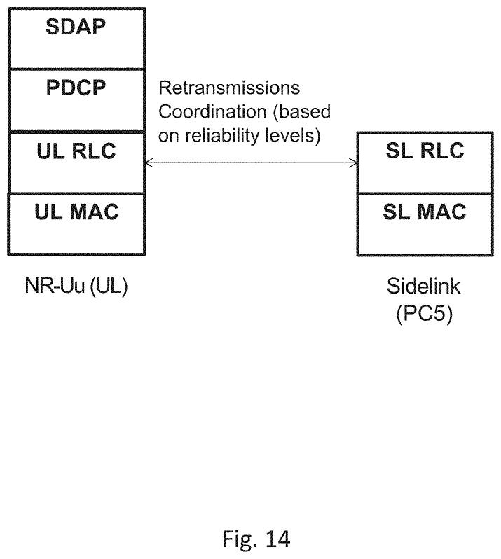

Especially for options II and III, in case that both communication modes have been selected for a specific V2X scenario and packet duplication has been enabled, then there is the need to avoid redundant packet re-transmission either by the Uu or the PC5, when a packet has been successfully received by one or the other interface. It is proposed to introduce the interaction between Uu and SL RLC layers (i.e. RLC control in AM) to notify successful reception of a “duplicate” packet or to inform about reliability levels of SL and Uu links for specific flows to avoid redundant re-transmissions. Retransmission coordination between the cellular and sidelink modes, based on the monitored reliability levels of each communication interface is proposed, as shown in FIG. 14. The RLC layer of the two communication modes (e.g. Uu, PC5) at the UE/vehicle side have a direct exchange of perceived reliability either per packet or in average. Another alternative is that the network (e.g. BS) provides the reliability information to the vehicle.

The disclosure in view of FIGS. 12, 13 and 14 applies to the device 100 of FIG. 1 above, as well as to the device 1500 of FIG. 15 and the device 1700 of FIG. 17 below.

FIG. 15 shows a device 1500 for receiving a message 1501 (e.g. user plane data packet) over a wireless communication system. The device 1500 can in particular be a UE, e.g. for use in a vehicle. To receive the message 1501, the device 1500 is configured to select one of an assisted mode 1502, an ad-hoc mode 1503, or a combined assisted and ad-hoc mode 1504. The selection can also comprise specification of one or more resources related to the selected mode, e.g. a predefined resource block used for the assisted mode. After the selection is performed, the message 1501 is received over the selected mode. The selection can e.g. be an initial selection, that is, the mode is selected for the first time, e.g. at startup. The selection can e.g. also include changing a presently used mode to a newly selected mode.

In other words, the device 1500 enables initial selection of a communication mode (which can include session/connection establishment) for a service, in particular a V2X service. The mode can be the assisted mode (e.g. cellular, or Uu), the ad-hoc mode (e.g. sidelink, or PC5), or the combined assisted and ad-hoc mode (e.g. cellular, or Uu, and sidelink, or PC5). Further, the device 1500 allows for dynamic switching of the communication mode, during the lifetime of the service. That is, during operation the mode can be newly selected, e.g. network-initiated, that is based on a request that is received from a network side device (e.g. a management device), but also UE-initiated, that is based on a determination of the device 1500 itself.

Moreover, the device 1500 obtains the availability indication of assisted mode (e.g. cellular, or Uu), or the ad-hoc mode (e.g. sidelink, or PC5), or the combined assisted and ad-hoc mode (e.g. cellular, or Uu, and sidelink, or PC5).

The availability indication can be used by device 1500 to determine whether to receive a message; or to select one of an assisted mode, an ad-hoc mode, or a combined assisted and ad-hoc mode and receive the message over the selected mode; or to manage a communication link.

Moreover, the device 1500 can use the availability indication to determine whether to establish a communication session or link; or to manage a communication failure; or to safely release a communication or application service; or to re-configure a communication with one or more devices. For instance, a UE can switch to another communication mode, based on the availability indication in order to assure the service continuity e.g., of a V2X service.

The device 1500 can obtain the availability indication by determining it, for instance by generating, or calculating, or estimating the availability indication based on any selection criteria.

Alternatively the availability information may be obtained by the device 1500 by receiving it from another device 100 or another device 1500, or a management device 1700.

For instance, the availability indication of the ad-hoc mode (e.g. sidelink, or PC5) can be obtained using e.g., the Channel Busy Ratio (CBR) of a sidelink resource pool that device 1500 measures or the QoS of a sidelink resource pool that device 1500 measures. In another example, the availability indication of the assisted mode (e.g. cellular, or Uu) can be obtained using e.g., the cell selection criterion S that device 1500 measures or the cell load.

To obtain the availability indication based on the selection criteria by the device 1500, the at least one selection criterion can be pre-stored in the device 1500, or determined by the device 1500, or externally provided to the device 1500.

The device 1500, can transmit the availability indication to a management device; or to another device; or to a network entity (e.g., Base Station); or an application function that is inside or outside a network operator.

The availability indication can be obtained by the device 1500 for at least one of the following configurations or combinations of these configurations:
per communication interface/mode (cellular, sidelink),
per radio access technology (e.g., 5G, 4G, IEEE 802.11p),
per type or category of service (e.g., safety, platooning, sensor sharing, convenience, automated driving etc.), since different services may have different QoS requirements,
per carrier,
per resource pool,
per quality of service class or category
per type of traffic, for example Unicast, groupcast, broadcast.

In order to obtain the availability indication for any of the above configurations, device 1500 can use selection criteria that is available at the UE or provided by neighboring UEs or network devices. For instance, to obtain the availability indication per type of service and also per communication interface/mode then the device 1500 uses radio measurements for the different communication interfaces (e.g., PC5, Uu) and monitored QoS information for the different types of services (e.g., safety, advanced, platooning etc.).

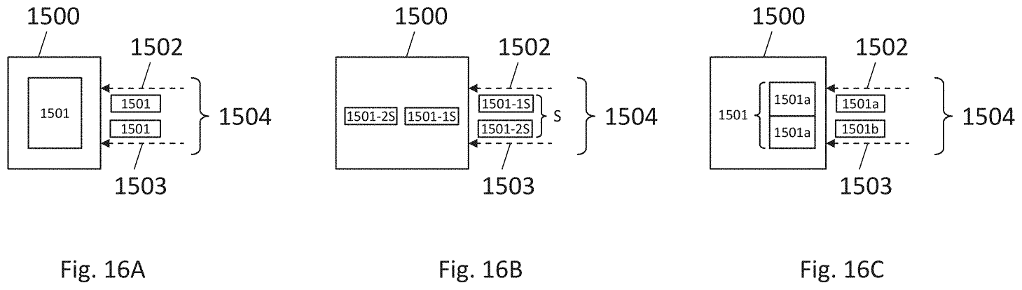

FIGS. 16A, 16B and 16C, a device 1500 according to an embodiment of the present disclosure in more detail. The device 1500 of FIG. 15 includes all features and functionality of the device 1500 of FIG. 15. To this end, identical features are labelled with identical reference signs. All features that are going to be described in view of FIGS. 16A-16C are optional features of the device 1500.

As it is shown in FIG. 16A, the device 1500 can be further configured to, in the combined assisted and ad-hoc mode 1504, receive the message 1501 over the assisted mode 1502 and receive the message 1501 over the ad-hoc mode 1503. In other words, the device 1500 can use both the assisted mode 1502 and the ad-hoc mode 1503 for increasing redundancy of a link.

Increasing redundancy of the link helps e.g. to increase reliability of communication. In this case, a data packet (e.g. each message) of a service or data flow (e.g. a V2X service) between two or more UEs or vehicles is received in both the assisted mode and the ad-hoc mode in a duplicated manner. If only one of the duplicated messages is received, because the other one is lost during transmission, communication can be still kept up.

As it is shown in FIG. 16B, the device 1500 can further be configured to, in the combined assisted and ad-hoc mode 1504, receive a first message 1501-1S over the assisted mode 1502 and receive a second message 1501-2S over the ad-hoc mode 1503.

In other words, the device 1500 can use both the assisted mode 1502 and the ad-hoc mode 1503 for link aggregation. That is, a first message 1501-1S is received over one mode, and a second message 1501-2S is received over the other mode (preferably simultaneously), and the messages are combined to one streams of messages, thereby increasing throughput of messages and decreasing latency of messages.

Link aggregation (which can also be called dual connectivity model) helps e.g. to increase throughput and reduce latency: In this case, different data packets/messages of a service or flow (e.g. a V2X service) between two or more UEs or vehicles are transmitted at both interfaces (split).

More specifically, the first message 1501-1S and the second message 1501-2S can belong to a same service S, e.g. a same V2X service.

The exact configuration of the combining of messages (1501-1S, 1501-2S) received by the one mode and the other mode (e.g. percentage or number of data packets/messages that should be received via the one or the other mode) can be decided either by the device 1500 (being e.g. a UE) or received by the device 1500 from a network side device (e.g. a management device).

As it is shown in FIG. 16C, the device 1500 can further be configured to, in the combined assisted and ad-hoc mode 1504, receive a first part 1501a over the assisted mode 1502 and receive a second part 1501b over the ad-hoc mode 1503, and combine the first part 1501a and the second part 1501b to obtain the message 1501.

In other words, the device 1500 can use both the assisted mode 1502 and the ad-hoc mode 1503 for link aggregation. That is, by receiving a first part 1501a that is sent over one mode, and by receiving a second part 1501b that is sent over the other mode (preferably simultaneously), and by combining said parts to obtain the message 1501, throughput of messages is increased and latency of messages is decreased.

In this example, link aggregation helps e.g. to increase throughput and reduce latency. Different parts of data packets or of messages of a service or flow (e.g. a V2X service) between two or more UEs or vehicles are received at both interfaces and combined afterwards.

In particular, the disclosure of FIGS. 3A-3C, FIG. 4 and FIG. 5 also applies for the receiving device 1500 in a corresponding manner.

In order to select a suitable communication mode, the device 1500 can also be configured to select the mode based on a configuration that defines the mode to be used for the message 1501. That is, depending on a message type, a mode can be selected by the device 1500. The configuration thereby can be pre-stored in the device 1500, or determined by the device 1500, or externally provided to the device 1500.

In order to select a suitable communication mode, the device 1500 can also be configured to select the mode based on at least one of the following selection criteria: QoS-information; a service type parameter (i.e. a parameter that defines a mode required by a service); involved mobile devices, in particular vehicles, or information based on other mobile devices or vehicles; radio information, in particular channel measurement; or location information or path information.

The device 1500 can also be configured to transmit at least one of the above selection criteria to a management device. Therefore, the respective selection criteria is obtained by the device 1500 before. In the management device, the selection criteria can be used for mode selection coordination and to improve overall QoS of a communication system managed by the management device.

To make a decision based on the selection criteria by the device 1500, the at least one selection criterion can be pre-stored in the device 1500, or determined by the device 1500, and/or externally provided to the device 1500.

The device 1500 can also be configured to receive a mode selection request, and select the mode based on the received mode selection request, or initiatively select the mode.

The QoS-information, upon which the mode selection can be based, can include a mapping between a first QoS-parameter and a second QoS-parameter, preferably wherein the first QoS-parameter relates to the assisted mode 1502, and wherein the second QoS-parameter or relates to the ad-hoc mode 1503. The mapping can either be pre-stored or generated in the device, or the mapping can be provided from the network. This mapping concept is described in view of FIG. 6 above in more detail.

The device 1500 can also be configured to perform the selection operation related to at least one of the following layers: an SDAP layer; a PDCP layer; a RLC layer; or a MAC layer. In particular, a configuration (such as one of the configurations above) that is received from another device, in particular a network device, can be dependent on a specific layer. Preferably, if the selection operation is performed (e.g. the routing) at the application layer, the device 1500 can comprise an interface to forward the selected mode or a configuration from the network layer to the application layer. This concept is described in view of FIG. 12 to FIG. 14 above in more detail.

The device, 1500 can also transmit the availability indication of assisted mode (e.g. cellular, or Uu), or the ad-hoc mode (e.g. sidelink, or PC5), or the combined assisted and ad-hoc mode (e.g. cellular, or Uu, and sidelink, or PC5) to upper layers. If the device is at the communication layer, then the upper layer is the application layer or an intermediate layer between the application and the communication layer. Hence, the application layer can use the availability indication for any application layer purpose. For instance, to determine whether to receive a message; or to select one of an assisted mode, an ad-hoc mode, or a combined assisted and ad-hoc mode and transmit the message over the selected mode; or to establish a service or accept a communication session with one or more devices. Moreover, the device, 1500 can transmit the availability indication to an application entity (e.g., an application of a UE, an application server, an application function etc.) on demand, or periodically, or triggered by an event.

FIG. 17 shows a management device 1700, e.g. a network device, for supporting a device for transmitting or receiving a message (e.g. user plane data packet) over a wireless communication system, such as the device 100 or the device 1500. The management device 1700 can e.g. be, or be included in a base station, or any other network device, e.g. an AMF or a V2X control function, or an application function, or an application server.

The management device 1700 is configured to: select one of an assisted mode 1701, an ad-hoc mode 1702, or a combined assisted and ad-hoc mode 1703; or select at least one selection criterion 1704; and transmit the selected mode or the selection criterion 1704 to the device for transmitting or receiving a message over a wireless communication system or to a base station.

This base station can in particular serve the device 100 for transmitting and/or the device 1500 for receiving a message over a wireless communication system.

The network device (i.e. the management device 1700) can also transmit a configuration comprising a plurality of modes that are assigned to certain messages, in particular for messages of a certain service and further, the configuration can also comprise a plurality of further devices with which the device 100 or 1500 communicates using specific modes. Such a configuration may have the following form:

RRC_Connection_Reconfiguration (sessionId,
{ListofUEs via Sidelink Interface, sl-V2X-ConfigDedicated},

### {ListofUEs via Cellular(Uu) Interface, RadioBearerConfig},

{ListofUEs via Both Interfaces, Type of Both Modes (Duplication, Splitting), sl-V2X-ConfigDedicated, RadioBearerConfig}

The management device 1700 can also be configured to receive selection criteria, in particular from a device for transmitting or receiving a message over a wireless communication system. In a specific embodiment of the disclosure, the UE sends the selection criteria to the network device. The network device selects the mode or the configuration and sends it back to the UE.

The management device 1700 can further be configured to generate a mapping between a first QoS-parameter and a second QoS-parameter, preferably wherein the first QoS-parameter relates to the assisted mode or wherein the second QoS-parameter relates to the ad-hoc mode, as it is e.g. described in view of FIG. 6 above.

The management device 1700 can also be configured to transmit the selected mode/and or the at least one criterion 1704 to another base station, e.g. if the management device is a base station, or to more than one base station, e.g. if the management device is a core network device. This in particular relates to an embodiment where the information is sent to two UEs in different cells.

The management device 1700 can also obtain the availability indication of assisted mode (e.g. cellular, or Uu), or the ad-hoc mode (e.g. sidelink, or PC5), or the combined assisted and ad-hoc mode (e.g. cellular, or Uu, and sidelink, or PC5).

The management device 1700 can also obtain the availability indication, using at least one of the selection criteria that is transmitted by device 100, or device 1500, or any other network entity, or an application entity. For instance, for the sidelink availability indication the management device can use information received by the UEs (e.g., CBR measurement reports) or neighboring BSs (e.g., resource pools CBR) etc.

The management device 1700 can obtain the availability indication for at least one of the following configurations or combinations of these configurations:
per communication interface/mode,
per radio access technology,
per type or category of service, since different services may have different QoS requirements,
per carrier,
per resource pool,
per quality of service class or category,
per type of traffic, for example Unicast, groupcast, broadcast.

The management device 1700 can transmit the availability indication to a transmitting device 100 or a receiving device 1500; or to another network entity; or to an application entity.

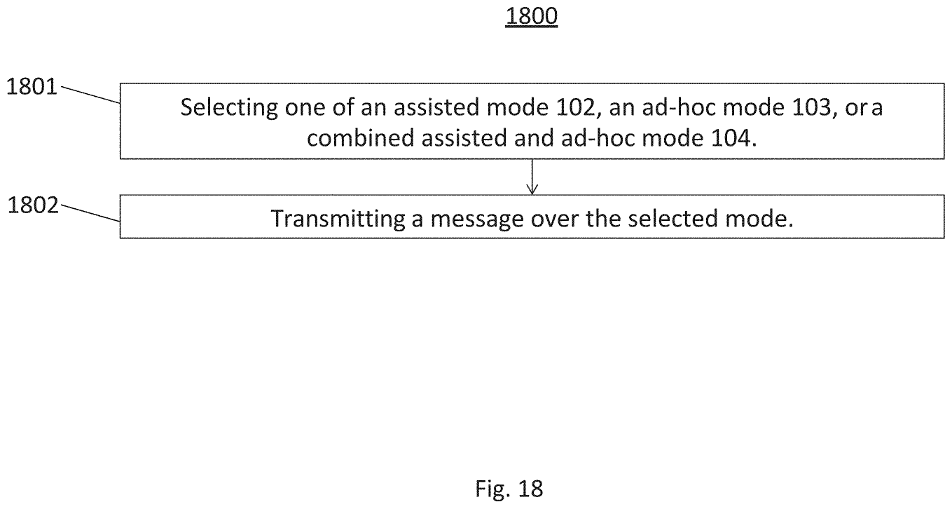

FIG. 18 shows a schematic view of a method 1800 according to an embodiment of the present disclosure. The method 1800 corresponds to the device 100 and is accordingly for transmitting a message 101 over a wireless communication system. The method 1800 comprises a first the operation of selecting 1801 one of an assisted mode 102, an ad-hoc mode 103, or a combined assisted and ad-hoc mode 104. The method 1800 also comprises a second operation of transmitting 1802 the message over the selected mode.

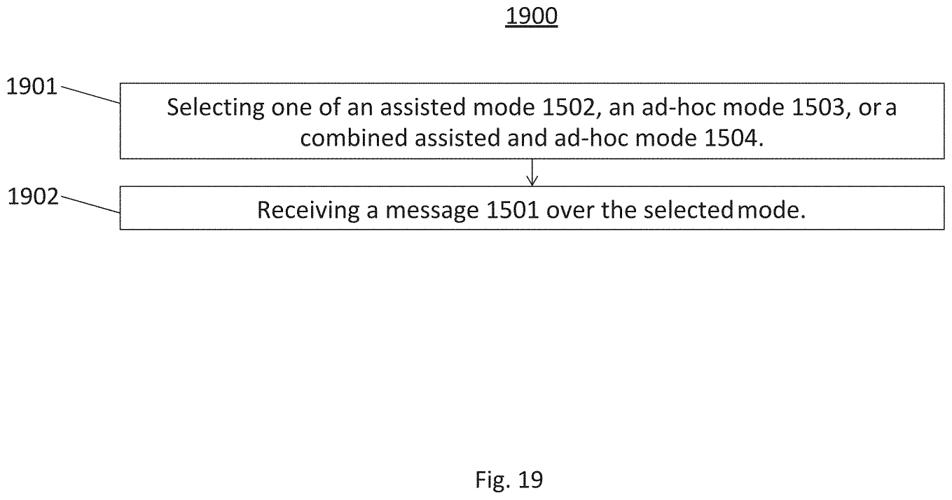

FIG. 19 shows a schematic view of a method 1900 according to an embodiment of the present disclosure. The method 1900 corresponds to the device 1500 and is accordingly for receiving a message 1501 over a wireless communication system. The method 1900 comprises a first operation of selecting 1901 one of an assisted mode 1502, an ad-hoc mode 1503, or a combined assisted and ad-hoc mode 1504. The method also comprises a second operation of receiving 1902 the message 1501 over the selected mode.

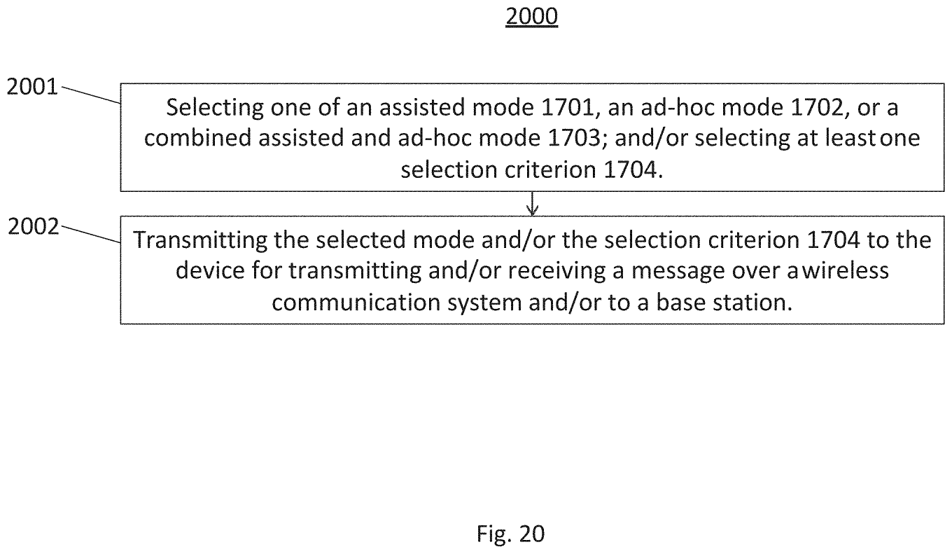

FIG. 20 shows a schematic view of a method 2000 according to an embodiment of the present disclosure. The method 2000 corresponds to the device 1700 and is accordingly for operating a management device 1700, in particular a network device, for supporting a device for transmitting or receiving a message over a wireless communication system. The method 2000 comprises a first operation of selecting 2001 one of an assisted mode 1701, an ad-hoc mode 1702, or a combined assisted and ad-hoc mode 1703; or selecting at least one selection criterion 1704; and transmitting 2002 the selected mode or the selection criterion 1704 to the device for transmitting or receiving a message over a wireless communication system or to a base station.

The present disclosure has been described in conjunction with various embodiments as examples as well as implementations. However, other variations can be understood and effected by those persons skilled in the art and practicing the claimed disclosure, from the studies of the drawings, this disclosure and the independent claims. In the claims as well as in the description the word “comprising” does not exclude other elements or operations and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

What is claimed is:

1. A device for transmitting a message over a wireless communication system, comprising:
at least one processor; and
a memory storing instructions, which when executed by the at least one processor, cause the at least one processor to:
obtain an availability indication; and
perform at least one of the following based on the availability indication:
determine whether to transmit a message;
determine whether to establish a communication session or link;
manage a communication failure;
safely release or re-configure a communication with one or more devices;
select one of an assisted mode, an ad-hoc mode, or a combined assisted and ad-hoc mode, and transmit the message over the selected mode; or
manage a communication link.

2. The device according to claim 1, wherein the availability indication is provided for at least one of the following configurations:
per communication interface or communication mode;
per radio access technology;
per type or category of service;
per carrier;
per resource pool;
per quality of service class; or
per type of traffic.

3. The device according to claim 2, wherein in the per communication interface or communication mode configuration, the availability indication is provided for at least one of the following modes:
the ad-hoc mode;
the assisted mode; or
combination of the ad-hoc mode and the assisted mode.

4. The device according to claim 1, wherein the instructions further cause the at least one processor to estimate the availability indication based on a configuration that defines a mode to be used for the message or at least one of the following selection criteria, or to transmit at least one of the following selection criteria to a management device:
QoS-information;
a service type parameter;
involved mobile devices comprising vehicles, or information based on other mobile devices,
radio information comprising channel measurement; or
location information or path information.

5. The device according to claim 4, wherein the at least one selection criterion is pre-stored in the device, determined by the device, or externally provided to the device.

6. The device according to claim 1, wherein the instructions further cause the at least one processor to:
receive a mode selection request; and
select a mode based on the received mode selection request; or
initiatively select the mode.

7. The device according to claim 5, wherein the instructions further cause the at least one processor to estimate the availability indication based on the at least one selection criteria and the configuration.

8. The device according to claim 1, wherein the instructions further cause the at least one processor to perform the selecting one of an assisted mode, an ad-hoc mode, or a combined assisted and ad-hoc mode related to at least one of the following layers:
an application layer;
a service data adaptation protocol (SDAP) layer;
a packet data convergence protocol (PDCP) layer;
a radio link control (RLC) layer; or
a media access control (MAC) layer.

9. A device for receiving a message over a wireless communication system, comprising:
at least one processor; and
a memory storing instructions, which when executed by the at least one processor, cause the at least one processor to:
obtain an availability indication;
perform at least one of the following based on the availability indication:
determine whether to receive a message;
determine whether to establish a communication session or link;
manage a communication failure;
safely release or re-configure a communication with one or more devices based on the availability indication;
select one of an assisted mode, an ad-hoc mode, or a combined assisted and ad-hoc mode, and receive the message over the selected mode; or
manage a communication link.

10. The device according to claim 9, wherein the availability indication is provided for at least one of the following configurations:
per communication interface or communication mode;
per radio access technology;
per type or category of service;
per carrier;
per resource pool;
per quality of service class; or
per type of traffic.

11. The device according to claim 10, wherein in the per communication interface or communication mode configuration, the availability indication is provided for at least one of the following modes:
the ad-hoc mode;
the assisted mode; or
combination of the ad-hoc mode and the assisted mode.

12. The device according to claim 9, wherein the instructions further cause the at least one processor to estimate the availability indication based on a configuration that defines a mode to be used for the message or at least one of the following selection criteria, or to transmit at least one of the following selection criteria to a management device:
QoS-information;
a service type parameter;
involved mobile devices comprising vehicles, or information based on other mobile devices;
radio information comprising channel measurement; or
location information or path information.

13. The device according to claim 12, wherein the at least one selection criterion is pre-stored in the device, determined by the device, or externally provided to the device.

14. The device according to claim 9, wherein the instructions further cause the at least one processor to:
receive a mode selection request; and
select a mode based on the received mode selection request; or
initiatively select the mode.

15. The device according to claim 12, wherein the instructions further cause the at least one processor to estimate the availability indication based on the at least one selection criteria and the configuration.

16. The device according to claim 9, wherein the instructions further cause the at least one processor to perform the selecting one of an assisted mode, an ad-hoc mode, or a combined assisted and ad-hoc mode related to at least one of the following layers:
an application layer;
a service data adaptation protocol (SDAP) layer;
a packet data convergence protocol (PDCP) layer;
a radio link control (RLC) layer; or
a media access control (MAC) layer.

17. A management device for supporting a device for transmitting or receiving a message over a wireless communication system, comprising:
at least one processor; and
a memory storing instructions, which when executed by the at least one processor, cause the at least one processor to:
obtain an availability indication;
select one of the following modes based on the availability indication: an assisted mode, an ad-hoc mode, or a combined assisted and ad-hoc mode;
transmit the selected mode or the availability indication to the device for transmitting or receiving a message over a wireless communication system.

18. The management device according to claim 17, wherein the instructions cause the at least one processor to receive selection criteria from a device for transmitting or receiving a message over a wireless communication system.

19. The management device according to claim 17, wherein the availability indication is provided for at least one of the following configurations:
per communication interface or communication mode;
per radio access technology;
per type or category of service;
per carrier;
per resource pool;
per quality of service class; or
per type of traffic.
